(19) United States
(12) Patent Application Publication
(10) Pub. No.: US 2026/0179048 A1
(43) Pub. Date: Jun. 25, 2026

(54) SYSTEM AND METHOD FOR USER NETWORKING

(71) Applicant: Belong For Me Corporation, Sewickley, PA (US)

(72) Inventors: Emily Stewart, Sewickley, PA (US); Mark Patton, Sewickley, PA (US)

(73) Assignee: Belong For Me Corporation, Sewickley, PA (US)

(21) Appl. No.: 19/127,161

(22) PCT Filed: Nov. 6, 2023
(86) PCT No.: PCT/US2023/036867

§ 371 Date: May 5, 2025

Related U.S. Application Data
(60) Provisional application No. 63/422,483, filed on Nov. 4, 2022.
(60) Provisional application No. 63/521,166, filed on Jun. 15, 2023.

(51) Int. Cl. G06Q 10/105

(52) U.S. Cl. CPC G06Q 10/105

(57) ABSTRACT

The present invention is directed to systems, methods, and storage media to provide customized recommendations for social opportunities and events to users within an organization. More directly, multiple users are matched with events based on personal preferences. Once a micro-community (also referred to herein as a “group”) is formed by the present invention, some embodiments of the system, method, and non-transitory computer-readable storage medium schedules network-building experiences (“events”) for the members of the micro-community to attend, based on the interests of the members of the micro-community. Non-limiting examples of these events include intramural sports, cooking classes, game nights and community volunteer opportunities.

### CROSS-REFERENCE TO RELATED APPLICATION

This application claims priority to U.S. Provisional Application Ser. No. 63/422,483, filed Nov. 4, 2022, and U.S. Provisional Application Ser. No. 63/521,166, filed Jun. 15, 2023, which applications are incorporated by reference herein in their entirety.

### BACKGROUND OF THE INVENTION

### Field of the Invention

The present invention is a system and method to facilitate networking among individuals within an organization.

### Background of the Invention

Since 1950, networking at companies has followed a similar pattern. There is a yearly rotation of holiday parties, happy hours, and company picnics, but while the events have stayed the same, the costs associated have not. Year after year, the cost of hosting traditional networking events has skyrocketed.

Now 70 years later, the cost of traditional networking, rewards, and non-cash incentive programs totals more than $38 billion annually according to Bersin & Associates. That is roughly 2% of all employer payroll costs with no demonstrated return on investment for the company. In highly competitive industries, networking spending reaches up to 8% of payroll to attract, motivate, and keep the talent needed to stay at the top of the field.

Organizations face immense pressure to create engagement and connection amongst employees but tracking the effectiveness of networking events continues to be a challenge. Employers invest millions of dollars into these events, but do not know who attended, if they enjoyed it, or even if they would come again. When employers give out perks like hockey tickets or gift cards, they have no idea if employees used these perks or if the tickets and gift cards were gifted away. Without basic metric tracking, employers are not able to measure the impact networking has on critical performance indicators, such as employee retention and satisfaction.

While metrics are critical for ensuring networking success, they do not encompass two of the biggest challenges that can make or break a company's events. Nothing compares to the two major consequences of ineffective networking: loneliness and an increased risk of sexual assault and harassment. Both consequences dramatically hurt employee and organizational health and are extremely expensive to fix.

Risk of Sexual Assault and Harassment. Sexual harassment and assault risk have plagued employer social events since their inception. The Equal Employment Opportunity Commission's Select Task Force on the Study of Harassment in the Workplace Report found that 60% of women have been sexually harassed at work. Harvard found two factors dramatically increase the likelihood of sexual assault and harassment: (i) alcohol, and (2) an imbalanced power dynamic. These factors turn networking events, such as happy hours and holiday parties, into breeding grounds for inappropriate and harmful behavior that impedes the goal of networking.

The Loneliness Epidemic. Our country is experiencing a loneliness epidemic. In 2018, Cigna found that 61% of Americans reported being lonely. This was before the coronavirus pandemic sent the country into lockdown for over a year. Isolation, disengagement, and loneliness were all magnified by the pandemic.

Networking was introduced to allow colleagues to feel connected to one another and to their workplace. However, networking events are exacerbating the loneliness experienced by employees in organizations. According to the University of Pennsylvania's groundbreaking research from 2018, traditional networking events are increasing companies' challenges with employee engagement and experience, not reducing them. When attending these events, employees are too anxious and fearful to find the courage to introduce themselves to new people. The larger the event, the worse the anxiety and stress.

The impacts of this anxiety and stress go beyond the event to employees' day-to-day experiences at the company. Lonely employees miss twice as many days for illness and five times as many days for stress. They are also twice as likely to think about quitting compared to non-lonely employees. Traditional networking events do not decrease employees' loneliness because building a new, long-term connection at a large event is rare. Wharton researchers warn, “solutions should be a lot smarter than just having more socials or company picnics on the weekends. They should be more relational, where two human beings can get together and relate so they start bonding.”

The present invention reinvents face-to-face organization networking by creating a personalized networking experience for individuals within an organization. While the invention can be used by virtually any type of organization, affiliation, group, club, etc. that has individual members associated with it, for the purposes of a non-limiting example here, the invention is described within the context of an employer with employees. This employer-implemented method and system has two components: (i) a mobile application for employees to enable personalized relationships within the organization, and (ii) an analytics platform for employers to measure impact. The present invention system and method embodies a solution that addresses the challenges for employees and organizations. This and other benefits of the present invention are explained more fully herein.

### BRIEF SUMMARY OF THE INVENTION

Three embodiments of the present invention are a system, a method, and a non-transitory computer-readable storage medium configured to build small groups of diverse individuals inside of organizations that comprise employer/employee or other types of group/members or use affiliations. In these embodiments, employees, users, or members utilize an app that implements at least part of the present invention's systems and methods. Through this app, employees take a brief questionnaire and the present invention's novel matching algorithm will create one-on-one and small groups of compatible people for them to network within their region. In one preferred embodiment of the present invention, these micro-communities or groups are typically between two to six employees or members. The present invention is intelligent enough to match employees or members in different parts of the organization who would rarely have the opportunity to meet through traditional networking. Over time the present invention method and system collects more personalized data on employees or members to provide higher quality recommendations. Employees are one example of a “user” and references herein to “employees” apply interchangeably as “employees”, “individuals”, “members” or “users”. Similarly, employers are one example of an “organization” and are references herein to “employers” apply interchangeably as “employers”, “customers”, “customer organizations”, “companies”, and “organizations”.

Once a micro-community (also referred to herein as a “group”) is formed by the present invention, some embodiments of the system, method, and non-transitory computer-readable storage medium schedules network-building experiences (“events”) for the members of the micro-community to attend, based on the interests of the members of the micro-community. Non-limiting examples of these events include intramural sports, cooking classes, game nights and community volunteer opportunities. Two critical mechanisms make the present invention's systems and methods unique and highly valuable. First, both introducing employees and planning bonding experiences funded by the employer for these new micro-communities are automated. Second, by creating custom micro-communities and events, the present invention is uniquely made to be effective for all employees. The present invention methods, systems, and storage mediums eliminate the anxiety of large group events and allow employees to get to know one another over tailored experiences in a low-pressure environment. This attacks loneliness at its core, to build a healthier employee and organization. Various embodiments of the present invention can be configured to first form a group of users and then match events to the features of that group. The systems and methods for those embodiments are analogous to one preferred embodiments, which entail matching events to users of the group and not to the group itself.

The micro-communities created by some embodiments of the present invention are matched from a pool of users. The pool can be narrowed down by many factors including but not limited to employee resource groups (“ERGs”), departments, and teams. Non-limiting examples of set networking pools from which an employer can choose include, company-wide, interdepartmental, intradepartmental, mentorship, buddy-program, orientation, promotion, conferences, internship or co-ops, or ERG (such as, Women in Technology, Environmental Social Governance Groups, or Volunteering). Alternatively, employers can create and define their own pools.

This enables company-selected groups to keep their employees directly connected as the world navigates into a more permanently hybrid working environment. Here is an example: 1,000 employees from a large technology company are all in the Pittsburgh area. One of those employees is Emily, a team member in the technology group. Various embodiments of the present invention can take the pool of employees and find a small group of other women in technology to go together to a baseball game. One embodiment of the present invention can create another small group of new hires and plan a day at an amusement park for them. The present invention can create a one-on-one mentorship with a female in leadership and plan a lunch introduction at a new restaurant in town. It can even create a fantasy football league for Emily and her technology team to participate in together for team bonding. The possibilities are endless to provide each employee with a custom networking experience.

The various embodiments of the present invention comprise automation, artificial intelligence, and a highly scalable integration engine for use with third party applications. Embodiments of the present invention deliver a quality experience using the data employees provide through a questionnaire. One embodiment of the questionnaire collects interests in broad categories, like art or sports. As employees accept or reject opportunities, the present invention systems and methods learn more about their detailed preferences like their interest in pottery or a specific team. When embodied in a mobile app, the present invention takes the interests of employees and automatically finds events matching that description from a catalog of vetted events, as described more fully herein.

Through the present invention's data analytics platform, the organization can track and measure the success of networking and the impact belonging has on an employee and employer. Employers can visualize their micro-communities intertwined to create a constellation of one genuinely connected community across the organization. The organizations can review their dashboards which empowers them to make data-driven, intelligent financial, and human resource strategy decisions. In certain embodiments, the present invention also can help to decrease the risk of work-related sexual harassment and assault by protecting employees by, for example, only allowing individuals of the same rank to connect at an experience where alcohol may be present. The ranking of users is an input provided by the organization when the organization uploads or updates information about its users. An alternative embodiment of the present invention prohibits an entity from becoming a partnered vendor if that entity's primary purpose is the sale of alcohol. One embodiment of the present invention system and methods schedules other events for employees of different ranks, such as volunteering at a food bank or going to an escape room.

In addition, the user is in complete control of accepting or rejecting each employee the present invention system and method recommend networking with. The program and events are designed to significantly decrease the opportunities for inappropriate behavior.

The various embodiments of the present invention help employers reach their human capital goals. These goals include the metrics listed above, like retention, attendance, and performance in addition to maximizing the potential for ERGs, facilitate and track volunteer days for Environmental Social Governance (“ESG”) goals and measure employee engagement goals and keep teams connected. Employee resource groups (“ERGs”) can be intimidating to join, the present invention creates belonging for marginalized groups on a micro-level. Employer's ESG goals heavily center around volunteer days. Some embodiments of the present invention systems and methods allow employers to create their own volunteer events and track all volunteer hours for the employer. This makes employer annual reporting much easier. The present invention also helps teams stay connected in a new virtual and hybrid world in which team bonding remains essential.

Another embodiment of the present invention systems and methods include making employee rewards and perks available to the employee's families and spouses. Incorporating families and spouses can be critical to help organizations keep employees in the workplace. Working parents frequently cannot attend traditional networking events. One embodiment of the present invention includes employees' families in the networking by creating events for them to bring their kids to, like a day at the children's museum or seeing a children's show. Today's networking events isolate mothers and fathers, but embodiments of the present invention better include parents with family targeted events. This creates a smarter, more inclusive employer.

Various embodiments of the present invention provide for a computer-implemented method for use and operation of the system and method steps of the present invention. In accordance with some embodiments, a user interface screen can be displayed on a terminal (e.g., computer, mobile device, etc.).

Embodiments of the present invention also include computer-readable storage media containing sets of instructions to cause one or more processors to perform the methods, variations of the methods, and other operations described herein.

Various embodiments of the present invention include a system comprising a display device, an input/output device, a memory, and a processor. The processor can be in communication with the display input/output device and operable to execute instructions stored in memory.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE SEVERAL VIEWS OF THE DRAWINGS

To facilitate understanding of the invention, the drawings and description illustrate certain embodiments thereof, from which the invention, various embodiments of its structures, construction and method of operation, and many advantages, may be understood and appreciated. The drawings hereby are incorporated by reference.

FIG. 1 is one embodiment of customer organization processes according to the present invention;

FIG. 2 is one embodiment of vetting portal processes according to the present invention;

FIG. 3 is one embodiment of customer report processes according to the present invention;

FIG. 4 is one embodiment of customer import processes according to the present invention;

FIG. 5 is one embodiment of matching helm processes according to the present invention;

FIG. 6 is one embodiment of automated processes according to the present invention;

FIG. 7 is one embodiment of user-initiated app processes according to the present invention;

FIG. 8 is one embodiment of event catalog processes according to the present invention;

FIG. 9 is one embodiment of a full system diagram according to the present invention;

FIG. 10 is one embodiment of individualized recommendation processes according to the present invention;

FIG. 11 is one embodiment of personalized event-group match processes according to the present invention;

FIG. 12 illustrates one embodiment of vendor portal processes according to the present invention;

FIG. 13 is one embodiment of employer helm processes according to the present invention;

FIG. 14 is one embodiment of a vetting portal my events page according to the present invention;

FIG. 15 is one embodiment of a vetting portal assigned events page according to the present invention;

FIG. 16 is one embodiment of a vetting portal event photo update page according to the present invention;

FIG. 17 is another embodiment of a vetting portal vetting questionnaire page with sample questions according to the present invention;

FIG. 18 is another embodiment of a vetting portal vetting questionnaire page with sample questions according to the present invention;

FIG. 19 is another embodiment of a vetting portal vetting questionnaire page with sample questions according to the present invention;

FIG. 20 is one embodiment of a vetting portal vetting questionnaire page with sample questions according to the present invention;

FIG. 21 is one embodiment of another page from the vetting portal vetting questionnaire according to the present invention;

FIG. 22 is one embodiment of a vetting portal edit venue form according to the present invention;

FIG. 23 is one embodiment of a vetting portal unclaimed event form according to the present invention;

FIG. 24 another embodiment of a vetting portal unclaimed events form according to the present invention;

FIG. 25 is one embodiment of a matching helm main page according to the present invention;

FIG. 26 is one embodiment of an app login page according to the present invention;

FIG. 27 is one embodiment of an app main page according to the present invention;

FIG. 28 is one embodiment of an app main page event accept page according to the present invention;

FIG. 29 is one embodiment of an app discover page according to the present invention;

FIG. 30 is one embodiment of an app discover event page according to the present invention;

FIG. 31 is one embodiment of an app my events page according to the present invention;

FIG. 32 is one embodiment of an app settings page according to the present invention;

FIG. 33 is one embodiment of an app example past event page according to the present invention;

FIG. 34 is one embodiment of an app post event survey page according to the present invention;

FIG. 35 is one embodiment of an app quest page according to the present invention;

FIG. 36 is another embodiment of an app quest page according to the present invention;

FIG. 37 is another embodiment of an app quest page according to the present invention;

FIG. 38 is another embodiment of an app quest page according to the present invention;

FIG. 39 is another embodiment of an app quest page according to the present invention;

FIG. 40 is another embodiment of an app quest page according to the present invention;

FIG. 41 is another embodiment of an app quest page according to the present invention;

FIG. 42 is another embodiment of an app quest page according to the present invention;

FIG. 43 is another embodiment of an app quest page according to the present invention;

FIG. 44 is another embodiment of an app quest page according to the present invention;

FIG. 45 is another embodiment of an app quest page according to the present invention;

FIG. 46 is another embodiment of an app quest page according to the present invention;

FIG. 47 is another embodiment of an app quest page according to the present invention;

FIG. 48 is another embodiment of an app quest page according to the present invention;

FIG. 49 is one embodiment of an event catalog event issues page with issue description according to the present invention; and

FIG. 50 is one embodiment of an event catalog edit current booking form according to the present invention.

### DETAILED DESCRIPTION OF THE INVENTION

The following describes example embodiments in which the present invention may be practiced. This invention, however, may be embodied in many ways, and the descriptions provided should not be construed as limiting. The following invention may be embodied as methods, systems, or devices. These detailed descriptions should not be taken in a limiting sense. The accompanying drawings are hereby incorporated by reference.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. All publications, patents, and patent documents referred to in this document are incorporated by reference herein in their entirety, as though individually incorporated by reference. If inconsistent usages occur between this document and those documents so incorporated by reference, the usage in the incorporated reference(s) should be considered supplementary to that of this document; for irreconcilable inconsistencies, the usage in this document controls.

The terms “connected”, “interconnected”, “in communication”, or “coupled” and related terms are used in an operational sense and are not necessarily limited to a direct physical connection or coupling. As an example, two or more devices, databases, websites, or platforms may be coupled directly, or via one or more intermediary channels or devices. They may be hardwired to each other or connected without hardwiring, such as by wi-fi, Bluetooth®, or cellular service. As another example, devices, databases, websites, or platforms may be coupled in such a way that information can be passed between them, while sharing or not sharing any physical connection with one another. Based on the disclosure provided herein, one of ordinary skill in the art will appreciate a variety of ways in which connection or coupling exists in accordance with the aforementioned definition.

The phrases “in some embodiments”, “in one embodiment”, “in various embodiments”, “according to various embodiments”, “in the embodiments shown”, “in other embodiments”, and the like generally mean the particular feature, structure, or characteristic following the phrase is included in at least one embodiment of the present invention and may be included in more than one embodiment of the present invention. In addition, such phrases do not necessarily refer to the same embodiments or to different embodiments.

If the specification states a component, element, part, or feature “may,” “can,” “could,” or “might” be included or have a characteristic, that particular component or feature is not required to be included or have the characteristic.

The terms “module” and “system” are used interchangeably herein to refer broadly to software, hardware, or firmware (or any combination thereof) components. Modules and systems are typically functional components that can generate useful data or other output using specified input(s). A module or system may or may not be self-contained. A module or system can incorporate one or a combination of processor(s) 8000, memory 8010, databases, and/or electronic system(s) 8020 to accomplish the stated purpose or to produce the stated output. An application program (also called an “application” or an “app”) may include one or more modules/systems, or a module/system can include one or more application programs. An application may be of the traditional type of “app” that can be downloaded to a mobile device, or it may be a software application that can be downloaded to a desktop or laptop computer. Alternatively, an “app” may be a program that can be launched and accessed via a web browser.

While the disclosure has been described in detail and referring to specific embodiments thereof, it will be apparent to one skilled in the art that various changes and modifications can be made without departing from the spirit and scope of the embodiments. Thus, it is intended that the present disclosure covers the modifications and variations of this disclosure provided they come within the scope of the appended claims and their equivalents.

It is to be understood that the invention may assume alternative variations and step sequences, unless specified to the contrary. It also is to be understood that the specific devices and processes illustrated in the attached drawings and described in this specification are simply exemplary embodiments of the invention. Hence, specific dimensions and other physical characteristics related to the embodiments disclosed are not to be limiting.

The present invention includes variations of methods 6000, systems 900, and storage media 7000 to build small groups 20 of individuals 10 within organizations 30 to enable, among other things, these individuals 10 to get to know one another in a less-anxiety inducing environment than traditional networking events and in a way that enhances the benefits of networking and decreases the risks associated with networking. In most embodiments, the individuals 10 in these groups 20 have common interests or traits. Additionally, most embodiments of the present invention can be embodied in an app 920 or a web-based program 920 that enables employees 10 to answer a questionnaire 704 and then the present invention's matching algorithms creates one-on-one and small groups 20 of compatible users 10 (“micro-communities 20”, “communities 20”, or “groups 20”) with whom individual employees 10 can network. In one preferred embodiment of the present invention when used in an employment setting, these micro-communities 20 consist of 2 to 6 employees 10 all in the same geographic region. Additional alternative embodiments entail the user 10 or customer organization 30 choosing to match the user 10 with other users 10 that they have already gone to prior events 251 with, instead of the more common method of prioritizing matching new users 10 into groups 20. However, alternative embodiments encompass micro-communities 20 of at least 2 individuals 10 within any geographic region. The present invention's systems 900, methods 6000, and storage media 7000 can match employees 10 in different parts of an organization 30 who would rarely have the opportunity to meet through traditional networking. Once a micro-community 20 is formed, various embodiments of the present invention systems 900, methods 6000, and storage media 7000 can automatically schedule network building experiences (matched events 251) for them to attend based, in part, on their interests and/or traits. Events 252 can include a wide variety of activities, including but not limited to any type of sporting event (to watch or play), any type of classes, game nights, clubs (such as book clubs), meals out, movies, theater performances, cultural events, music events, volunteer opportunities, and all such events can be in-real-life or virtual. Over time the present invention systems 900, methods 6000, and storage media 7000 collect more personalized data and information on employees 10 to continually provide higher quality recommendations. By creating custom communities 20 and booking events 253, the present invention is uniquely impactful for employees 10 and useful to employers 30.

The various embodiments of the present invention can decrease the risk and downsides of traditional networking events, such as work-related sexual harassment and assault. In some embodiments of the present invention, only individuals 10 of the same rank 110 are invited to an event 251 where alcohol may be present. Alternative events 251 can be scheduled for employees 10 of different ranks, such as volunteering at a food bank or going to an escape room. Additionally, some embodiments of the present invention can eliminate the anxiety of large group events by allowing employees 10 to get to know one another during tailored experiences in a low-pressure environment. The result is building a healthier employee 10 and organization 30 with less employee loneliness.

Through the data analytics platform of the various embodiments of the present invention, the organization 30 can track and measure the success of networking and the impact it has on an employee 10 and employer 30. Employers 30 can visualize their many micro-communities 20 intertwined to create a constellation of a single truly connected community. Additionally, organizations 30 can review their dashboards, empowering them to make data-driven, intelligent, financial, and human resource strategy decisions.

The various embodiments of the present invention enable an employer 30 to redirect employee spending to custom-designed employee experience plans, driven by the metrics that are important to decision-making. The various embodiments of the present invention reduce employee 10 loneliness and can be evaluated based upon the following metrics to demonstrate cost savings and reputational benefits for an employer 30.

Through the present invention's systems 900, methods 6000, and storage media 7000 an organization 30 can track and measure the success of networking and the impact belonging has on an employee 10 and employer 30. The effectiveness of the present invention can be measured by using a wide variety of metrics. The following are a subset of metrics that can be favorably impacted by the present invention: (1) reducing attrition; (2) reducing absenteeism; (3) increasing individual and team performance and productivity; (4) reducing the risk of workplace sexual assault and harassment; (5) improving organizational ratings; and (6) improving ESG reporting and scores.

Attrition. Decades ago, emerging research changed the collegiate world forever. Universities found a close correlation between a student's sense of connection to campus life and the retention rate from incoming students to graduates. Colleges across the country built upon this idea of belonging and experience to decrease the number of students who transfer or leave the university. Organizations 30 that implement similar models to introduce the concept of belonging into employees' lives could also see a decrease in attrition. The ultimate barrier to successful implementation of a program to develop belonging is loneliness. In 2019, Cigna found that lonely employees 10 are twice as likely to think about quitting compared to their non-lonely peers.

Younger employees are the greatest challenge when it comes to retention. Gallup found that over 50% of Millennials and 75% of Generation Z have reported quitting a job due to mental illness. Mental illness frequently manifests as loneliness, linking these issues for employers 30 looking to increase retention. Taken together, these issues can create devastating attrition rates for employers 30 and negative financial impacts. The average cost of replacing an employee 10 is over 21% of their salary. That does not factor in lost time, or the cost to train a replacement. Increasing retention is a vital step in increasing organizational efficiency and saving money. By providing employees 10 with opportunities to belong, connect, and network in a more meaningful way, organizations 30 attack the loneliness that is at the center of attrition issues.

The systems 900, methods 6000, and storage media 7000 of the present invention decrease organizational attrition rates. When employees 10 build micro-communities 20 that they feel connected to and trust, their commitment to the organization 30 increases and organizational turnover decreases. Highly engaged teams have 59% less turnover than in teams with poor engagement according to a recent Gallup study. By focusing on increasing engagement by reducing loneliness, the present invention can decrease the desire by up to 50% for formerly lonely employees 10. The money that was previously spent on backfilling roles and training new employees 10 can be redirected to more effective spending within the organization 30.

Absenteeism. Loneliness and social isolation negatively impact employees' mental health and directly contribute to absenteeism. Cigna found that lonely individuals miss twice as many days due to illness and five times as many days due to stress. Loneliness was identified as the number one contributing factor to whether an individual will suffer from mental health issues. Over 57% of absenteeism in companies is due to stress and anxiety. Each time an employee needs time to care for their mental health, their absence is felt throughout the entire team.

The Society for Human Resource Management found an average of 3.2% of an employee's salary is spent on paid sick time off. For employees experiencing loneliness that figure can be two to three times greater according to Cigna. Various embodiments of the present invention help reduce absenteeism by monitoring an employee's sense of belonging on a loneliness scale and directing additional funding for events 252 to those employees 10. The present invention also can actively encourage at-risk employees 10 to attend events 252 and build them micro-communities 20 defined by their interests in which to belong. When an employee 10 feels a part of their organization 30, absences decrease by over 68%. One impact of the present invention can be a reduction of sick time off across all employees 10, and particularly for lonely employees 10.

Individual and Team Performance. Individual and team performance also is impacted by loneliness. Researchers have long studied how loneliness can cripple an employee's ability to be productive and to fulfill basic job requirements. Recent studies demonstrate how an employee's individual performance decline can spread to create a decline in team performance. Organizational psychology researchers at Wharton explain that loneliness is “a social phenomenon as observable by an employee's coworkers”. When an employee becomes lonely, coworkers can sense the disengagement and withdrawal from the environment, creating a ripple effect of loneliness that sweeps through the team.

When coworkers of lonely employees must step in to help finish the work of their disengaged peer, the team's morale, performance, commitment to the organization, and retention all plummet. The researchers identified that, once an individual was perceived to be lonely, coworkers would also retreat. With coworkers also withdrawing, the lonely employee finds it even harder to find belonging within the team. This total team retreat leads to colleagues not sharing needed resources, and ultimately a collapse in the team's ability to work together.

Organizational morale and productivity have declined steadily over the past decade. According to Harvard, an incredible 75% of cross-team functional projects fail, primarily due to new team dynamics—employees are fearful to speak up and voice concerns and are unable to effectively communicate with one another.

The opportunity to increase performance is enormous. A groundbreaking 2017 Gallup report found that highly engaged teams deliver 21% greater profitability. Researchers also found that engaged teams achieved a 10% increase in customer ratings and a 20% increase in sales. The various embodiments of the present invention build diverse micro-communities 20 that allow employees 10 of different departments to engage and get to know one another in a casual setting. By developing a web of micro-communities 20, employees 10 from various functions can get to know one another before a project even begins. This promotes a healthy work environment where employees 10 are comfortable voicing opinions and concerns to keep projects on track and on budget.

Reducing the Risk of Sexual Assault and Harassment in the Organization. As mentioned previously, two factors dramatically increase the likelihood of sexual assault and harassment—alcohol and an imbalance in power dynamic. The various embodiments of the present invention help to reduce the risk of sexual assault and harassment in the organization by eliminating events whose sole activity is drinking, like happy hours at bars. Instead, the focus is on planning more creative events 252 for employees 10 to enjoy. This is accomplished through a variety of steps including in some embodiments, only allowing users 10 of the same rank to connect at an event 252 where alcohol may be present. For employees 10 from different ranks, the present invention focuses on events 252 such as volunteering at a food bank or going to an escape room as examples of events 252 where alcohol is not present. In building a program that considers the most prevalent factors of sexual harassment and assault, the present invention greatly decreases the opportunities for inappropriate behavior.

Managing Reviews of the Organization. Over the past decade, various online companies (such as Glassdoor®) have provided an inside look into the employee experience for prospective employees, as well as ESG rating firms, investors, and the public. Organizations have struggled to identify which employees are having a positive experience to encourage them to create reviews of the organization. Employers who have encouraged all employees to take these surveys or write reviews are often surprised by the number of negative reviews from unhappy employees just looking to vent.

The present invention solves this challenge by identifying engaged employees 10 who are having positive experiences through platform surveys. One embodiment of the invention can send Glassdoor® or other review site review requests to these employees 10 increasing the likelihood that positive reviews of the company 30 are shared rather than primarily employees 10 looking for a place to share frustrations.

The higher an organization's Glassdoor® score, the easier the organization's recruiting efforts become, as the quantity and quality of job applicants for open positions will expand at no additional cost. The present invention also can help protect the organization from reputational damage resulting from lower Glassdoor® scores, which are easily found on the Internet by applicants looking to learn about your employer brand.

Environmental, Social, and Governance Goals. In today's world, organizations are increasingly choosing to publish ESG reports to demonstrate their commitment to the environment, employees, the community, and other stakeholders. A key element of any company's social contribution is how much their employees volunteer in the community. Volunteering events are also a great opportunity to strengthen employee association, with both the company and the greater community around them.

Setting up time to volunteer can be a huge challenge for employees 10. The systems 900, methods 6000, and storage media 7000 of the present invention recommend volunteer events 252 based on employees' individual interests, and tracks participation while measuring the impact the events 252 have on the organization 10. Through these events 252, employees 10 who would not typically network with one another but share an interest in similar causes can be introduced to create an even more connected employee web.

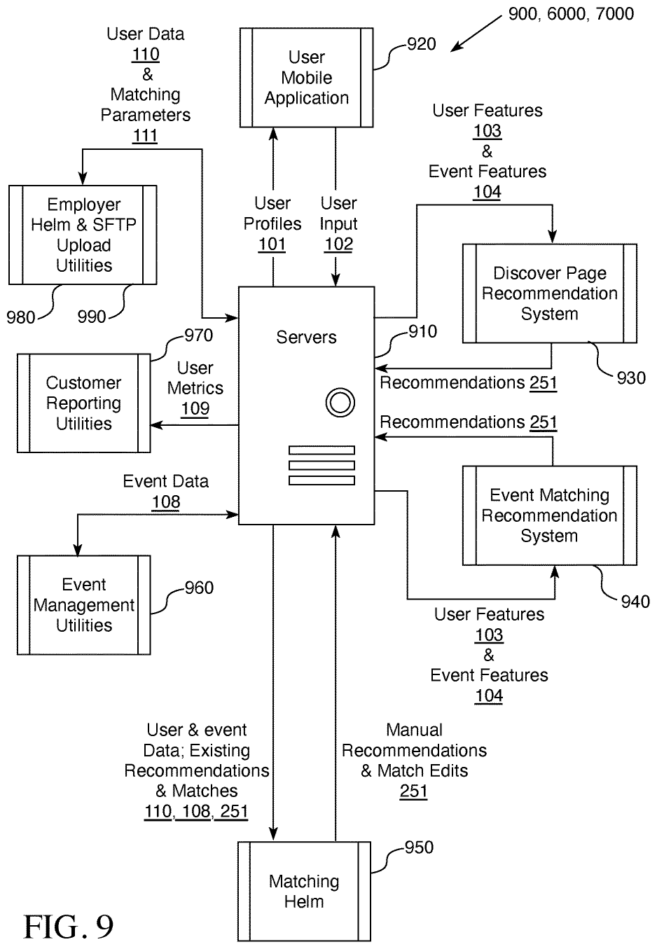

One embodiment of an overall system 900 and methods 6000, which can be embodied in a non-transitory storage medium 7000, of the present invention is illustrated as a flowchart in FIG. 9. As shown in FIG. 9, the systems 900, methods 6000, and storage media 7000 of the present invention comprise multiple pieces/components/modules that integrate with each other to create a fully functional service for both customers 30 and users 10. Specific embodiments of these individual modules are described in more detail as follows. For ease of discussion, the system 900 embodiments of the present invention are discussed, but it will be understood to one skilled in the art that the illustrated elements of the various systems 900 also can be embodied or translated into various methods 6000 and can be encompassed in various non-transitory storage media 7000 as further described herein. Additionally, all variations of all embodiments of the present invention described herein can be configured to be used with one or more than one users 10.

One preferred embodiment of a system 900 according to present invention comprises a system 900 for matching a user 10 with other users 10 in an organization 30 in connection with events 252, the system 900 comprising: at least one processor 8000, and a memory 8010 coupled to the at least one processor 8000 comprising instructions executable by the at least one processor 8000. The at least one processor 8000 is operable, when executing the instructions to perform the following six steps/actions. The processor 8000 is operable to receive event features 104 that are transmitted to the processor 8000. The event features 104 are predetermined by screening and selection based on a review of the event 252. The processor 8000 is operable to receive user features 103 from at least one user 10 that are transmitted to the at least one processor 8000 for creation of at least one user profile 101 based upon user input 102 and user data 110, as well as user interest ratings of outcomes 740 and/or events 251, 252. Then the processor 8000 generates personalized recommended events 251 to the at least one user 10 based upon the user interest ratings of the at least one user 10 and for the at least one user 10 to rate 708 and accept or decline 710 the recommended event 251. The processor 8000 generates an event invitation 112 including event details 108 to the at least one user 10 for an event accepted 250 by the at least one user 10. Then the processor 8000 updates the user profile 101 of the at least one user 10 based upon the at least one user interest rating and/or selection of events generated to, accepted by, declined by, and/or attended by the at least one user 10. Finally, and optionally, the processor 8000 generates new personalized recommended events 251 to the at least one user 10 on a periodic schedule and based upon the updated user profile 101 of the at least one user 10.

Some variations on the systems 900 described above entail the step of generating personalized recommended events 251 to the user 10 based upon the user interest ratings of the user 10 as comprising: (1) generating recommended events 251 through a discovery page recommendation module 930 to the user 10 based upon the user's user profile 101 and for the user 100 to rate 708 by interest; (2) updating the user profile 101 based upon the user's interest ratings of the recommended events 251; and (3) generating matched events 251 through an event matching recommendation module 940 to the user 10 based upon the updated user profile 101 and for the user 10 to accept or decline 710.

As shown in FIG. 9, the server(s) 910 of this embodiment of the present invention occupy a central position in the system 900. The servers 910 are comprised of, contain, or have incorporated into them the databases that house customer and regional data, the containers that operate individual customer's 30 instances of the present invention's services, and all scripts and automated processes required to maintain the proper running of the system 900 for all organizations 30 and users 10. The containers are also encased within the “servers 910” object in FIG. 9. A ‘container’ in this context is a packaged set of software that can run on a virtualized server instance. The servers 910 also contain or house one or more processors 8000, memory 8010, and/or electronic systems 8020 to accomplish the goals and processes the necessary input to achieve the necessary outputs of each server 910. Each customer organization 30 can have their own container running their instance of the present invention systems 900, methods 6000, and storage media 7000.

As shown in FIG. 9, the user mobile application 920 can be embodied as a mobile device application (or in alternative embodiments a web browser accessible platform) that is comprised of the various interfaces which users 10 require to interact with the system 900 of the present invention. The user mobile application 920 draws user profiles 101 from the servers 910 and sends various user input 102 back to those servers 910. The user input 102 is personal information that a user 10 enters into the present invention about themselves. These processes are explained in more detail in the Application Processes 700 section. In one preferred embodiment of the present invention systems 900, the user profile 101 of the at least one user 10 is generated initially, at least in part, from answers provided by the at least one user 10 to a user questionnaire 704, wherein the answers are associated with weighted parameters within the process of generating personalized recommended events (usually through the various recommender modules 930, 940, 950.) Additionally, in certain preferred embodiments of the present invention's systems 900, the user interest ratings can be provided in response to a questionnaire 704.

The discover page recommendation module 930 (FIG. 9) is a machine learning program that takes user features 103 and event features 104 from the servers 910 as input, and outputs personalized recommendations or events 251 specifically for use on the discover page 705 of the mobile application 920. These recommendations 251 are tailored and personalized for each individual user 10. User features 103 can be all or a subset of the combination of user inputs 102 and user data 110.

The event matching recommendation module 940 (FIG. 9) is a machine learning program that takes user features 103 and event features 104 from the servers 910 as input, and outputs personalized event recommendations 251 and user group recommendations 251. These suggested event matches or recommendations 251 will be displayed as event invitations 112 within the mobile application 920 for users 10 to accept or decline to attend 710. In FIG. 9, the recommendations 251 coming out of the DP Recsys 930 are personalized event recommendations 251 for a specific user 10 that shows on their discover page 705. The recommendations 251 coming out of the EM Recsys 940 are comprised of the combined user-to-event event recs and user-to-user group recs (collectively, recommendations 251), which are then sent to a user 10 to accept or decline to attend 710.

These event features 104 factor into the system's 900 screening and selection step. For various embodiments of the present invention's system 900, the screening and selection of the predetermined event features 104 is based review of features of the event vendor, event location, event venue and/or event activity, including, without limitation, and one or more of the following factors: cost of the event, date and time of the event, vendor name, vendor contact email, vendor contact phone number, vendor contact preference, vendor website, vendor address, venue name, venue address, venue website, venue max capacity, venue weather seasonal, venue parking availability, public parking availability, public transportation availability, parking recommendations, venue payments accepted, venue dining culture, venue age restrictions, venue restroom accessibility, venue entrance accessibility, venue exit accessibility, venue parking accessibility, near accessible parking, venue accessibility concerns, venue number of ratings, venue average ratings, event title, event time, event description, event categories, event subcategories, event average duration, event average duration outside, ages targeted, ages present, meeting spot, average cost, review cost, parking cost, dietary options, safety concerns, alcohol availability, red flags present, event waiver requirement, event vaccine requirement, event mask requirement, administrator rating of venue, administrator rating of vendor, event payment types accepted, groups targeted, pet friendliness, types of food offered, family friendliness, event competitiveness, educational/workshop/class focus, reoccurring event information, event daily admissions information, and/or event photos. This is a nonexclusive list of factors that can be incorporated into this screening and selection step. It will be obvious to one skilled in the art that these factors will vary based upon the type of event 252, the organization 30, the user 10, the goals for the user-to-event matching, and the application of the system 900 within a given industry.

The matching helm 950 (FIG. 9) is a supplementary tool to allow administrators 40 to manually interface with, and manually supplement, the output 251 of the various recommender modules 930, 940. The regional event directors 40 can use the matching helm 950 to manually create both discover page recommendations 251 and event matches 251, as well as edit any existing recommendations or matches 251, whether those recommendations or matches 251 were created through the different algorithms or manually by an administrator 40 through the matching helm 950. The matching helm 950 reads user data 110, event data 108, and recommendations 251 (which includes both the user's inputs 102 and the user's profile information 101), as well as existing recommendations and matches 251, from the servers 910, and sends any saved changes from the regional event director 40 back to the servers 910 as updates to the data. In the context of the discover page recommender modules 930, its output is strictly a recommendation of an event 251 that a user 10 may be interested in, with the intent of collecting interest data from the user 10 to use in future recommendations and event matches 251. In the context of the event match recommender module 940, the output is a recommend matched event 251 that is actually fed to the user 10 with the intent that the user 10 will accept or decline the event 251. Both modules 930, 940 output recommended events 251; however, those recommended events 251 have different purposes within the system 900. These processes are detailed more thoroughly in the matching helm data flow 500 section below.

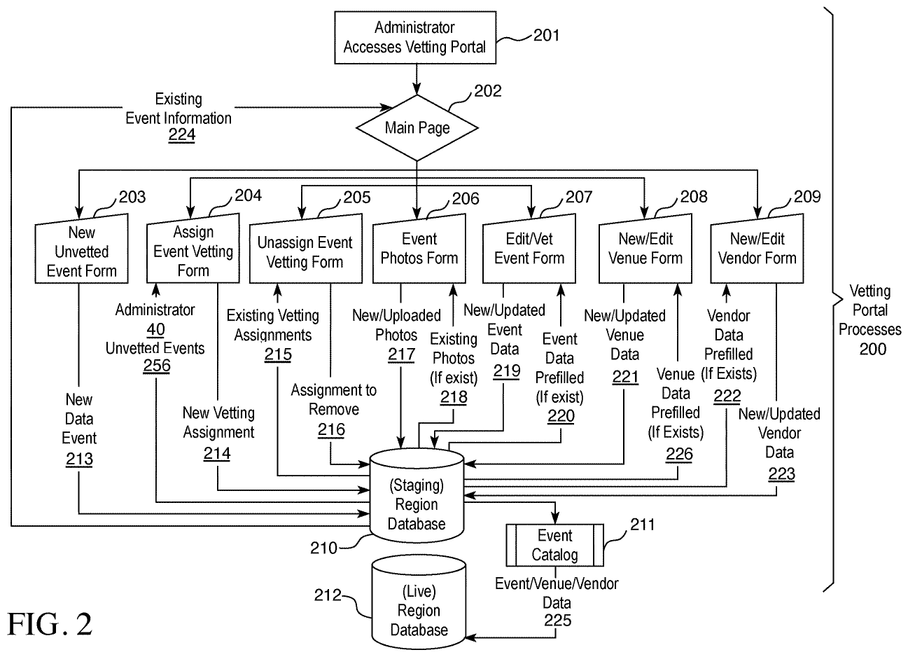

The event management utilities 960 (FIG. 9) are, in this embodiment, a trio of tools that are used to manage event data 108 in the various embodiments of systems 900 of the present invention. In the vetting portal 200, events 252 in a specific region are vetted by administrators 40 (FIG. 2). In the event catalog interface 211, individual event bookings 253 are created using templates 254 of the vetted events 252 by administrators 40 (such as regional event directors 40 or solutions specialists 40). The vendor portal 1200 is a version of the event catalog 211 specifically tailored to partnered vendors 55. Partnered vendors 55 can manually create and cancel events 252 tied directly to their records through the interface provided within the vendor portal 1200. These processes are detailed in depth in the vetting portal data flow 200, event catalog data flow 800, and vendor portal data flow 1200 sections. These elements are included or encompassed by the event management utilities 960. For general clarification, events move through the system 900 as follows. A rough event starts as an unvetted event 265. Unvetted events 256 go through the processes detailed herein to become vetted events 252 (or events 252). A matched event, recommended event, or recommendation 251 is a vetted event 252 that has been matched to a user 10 or to a group 20. A matched event 251 then becomes an accepted event 250 or an unaccepted or declined event 257 depending upon the decision made by the user 10.

The customer reporting utilities 970 (FIG. 9) of the present invention provide customers 30 with the ability to access reports of their associated users 10 and their usage metrics 109 of the system 900. These reports can be anonymized to protect the users' privacy. This process is detailed more thoroughly below in the customer report download process 300 section.

The employer helm 980 and automatic upload utilities 990 (FIG. 9) provides a method for customers 30 to upload data files 110 of their associated users 10 into the servers 910. The automatic uploads 990 can be performed on a set schedule, whereas the employer helm 980 allows manual uploads and manual updates only. These processes are detailed more thoroughly below in the customer data import process 400 section.

### Vetting Portal Data Flow 200

FIG. 2 illustrates the vetting portal processes 200. An administrator 40 accesses 201 the vetting portal 200 and is directed to the vetting portal main page 202, which in some embodiments can be the my events page 1440. From there, the administrator 40 can add data to, delete data from, or edit data through any number of the following forms: (1) the new unvetted event form 203, (2) the assign vetting time form 204, (3) the unassign vetting time form 205, (4) the event photos form 206, (5) the edit/vet event form 207, (6) the new/edit venue form 208, and/or (7) the new/edit vendor form 209. As illustrated in FIG. 2, each of these forms feeds data to and/or receives data from a staging region database 210. The staging region database 210 feeds data to the event catalog 211, which sends event/venue/vendor data 225 to the live region database 212. Additionally, the staging region database 210 communicates existing event information 224 to the vetting portal main page 202.

FIG. 2 illustrates which data is communicated between these individual forms and the staging region database 210. The new unvetted event-form 203 sends new event data 213 to the staging region database 210. The assign vetting time form 204 sends new vetting assignments 214 to the staging region database 210 and receives from the staging region database 210 administrator 40 and unvetted event 256 information. The unassign vetting time form 205 sends assignments to be removed 216 to the staging region database 210 and receives from the database 210 existing vetting assignments 215. The event photos form 206 sends new/uploaded photos 217 to the staging region database 210 and receives from it existing photos (if they exist) 218. The edit/vet event form 207 sends new/updated event data 219 to the staging region database 210 and receives from it event data prefilled (if it exists) 220. The new/edit venue form 208 sends new/updated venue data 221 to the staging region database 210 and receives from it venue data prefilled (if it exists) 226. The new/edit vendor form 209 sends new/updated vendor data 223 to the staging region database 210 and receives from it the vendor data prefilled (if it exists) 222.

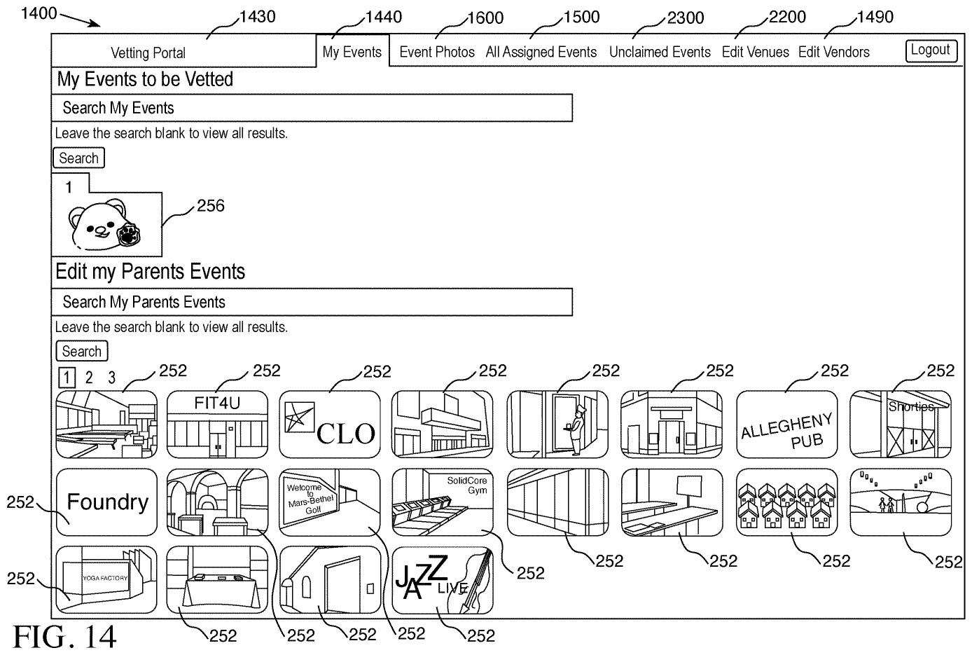

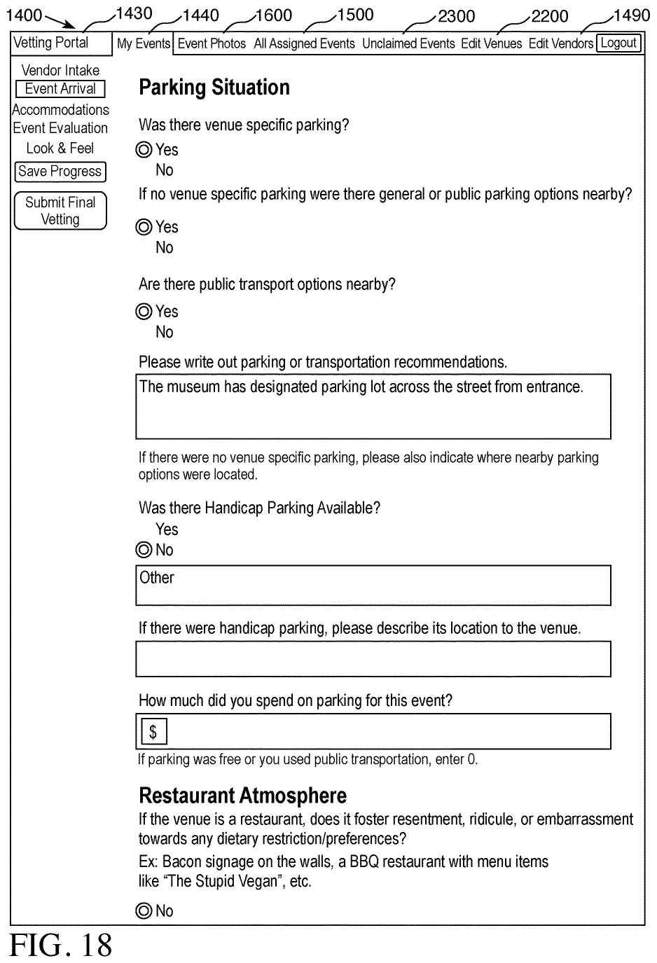

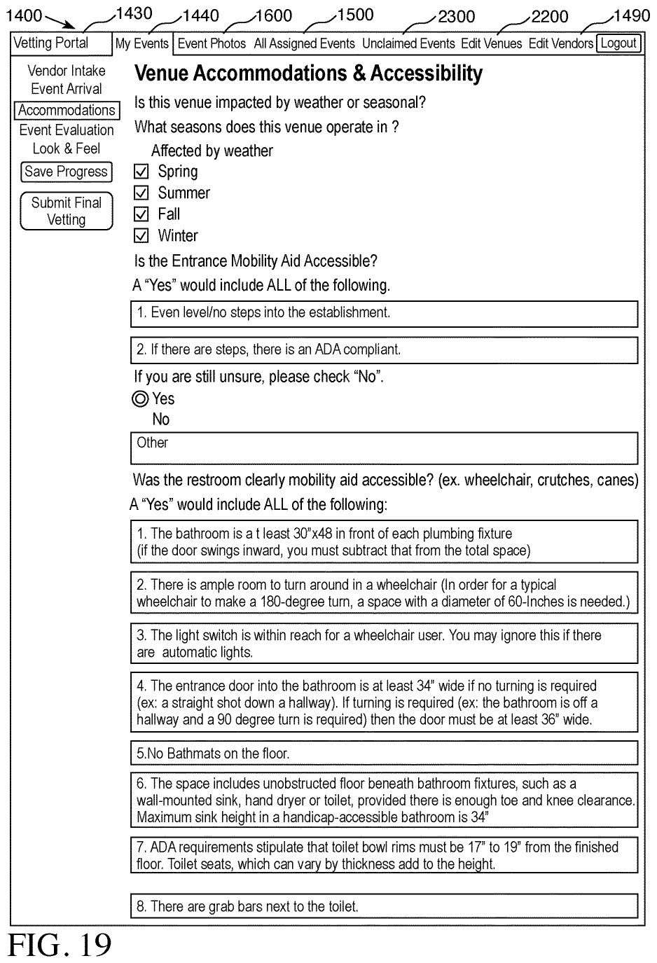

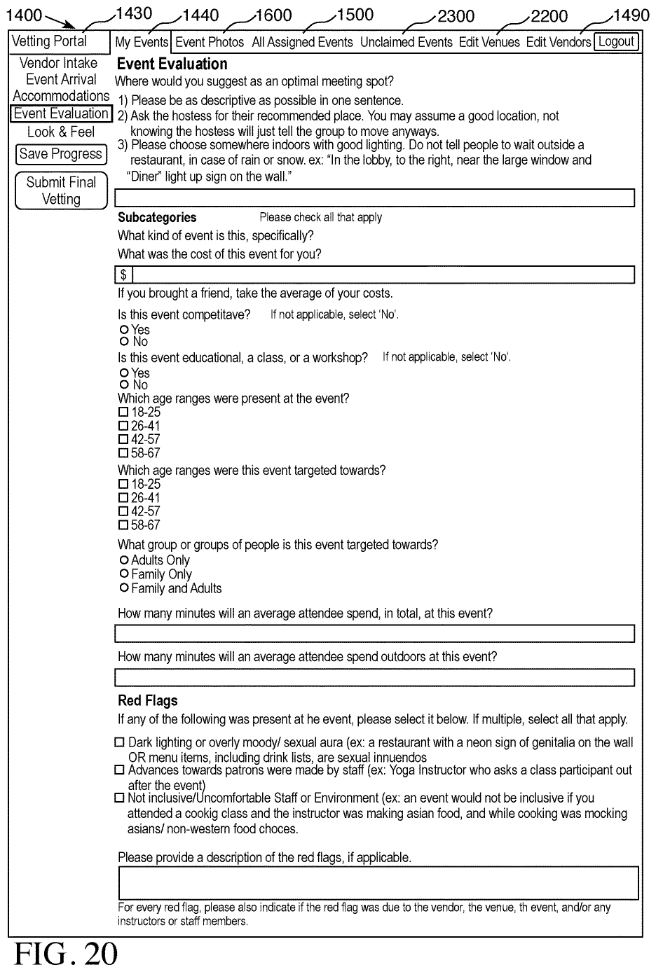

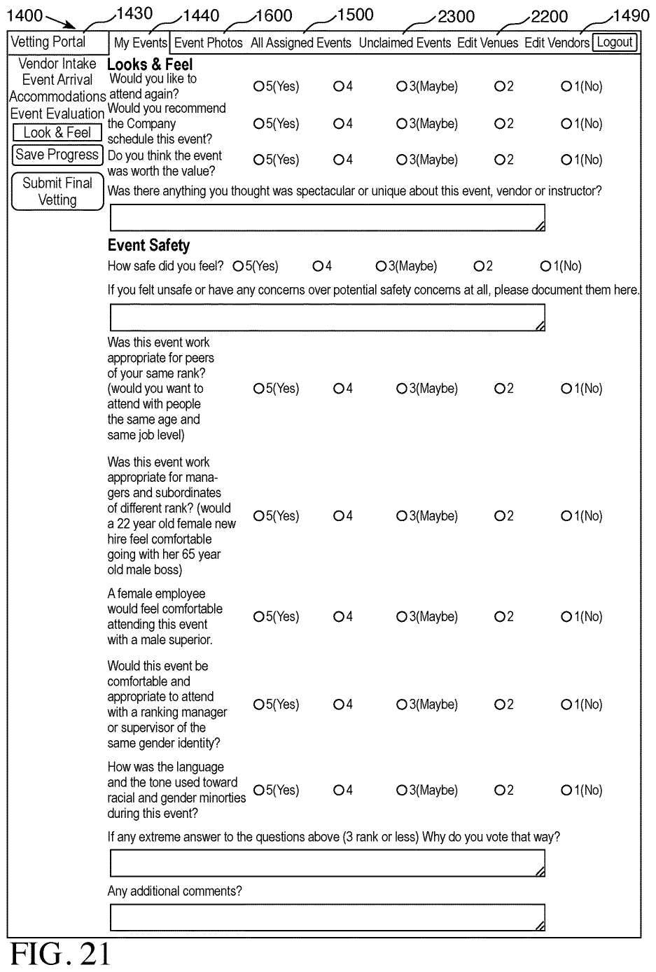

One embodiment of the vetting portal processes 200 according to the present invention is illustrated in FIGS. 2 and 14 through 24. As shown in those figures, an administrator 40 logs into the vetting portal (shown as part of the system in FIG. 2 at 201 and as specific embodiments shown in FIGS. 14 through 24 at 1400) via, for example, a standard login page that requests login information such as at least an email address or username and a password or other similar secure login technology (such as, facial recognition software, fingerprint or voice recognition software, use of an authenticator technology, etc.) For this embodiment of the present invention, an administrator 40 in this context is one of: an event coordinator, a solutions specialist, or a regional event director. Once logged in, some embodiments of the present invention can be configured so that the administrator 40 is, by-default, shown on my events page 1440 (see FIG. 14), with a persistent navigation menu bar 1430 at the top of the page that can be used to access other pages (specific examples at 1490, 1500, 1600, 2200, and 2300 in FIGS. 14 to 24). In some embodiments of the present invention, administrators 40 (such as solutions specialists 40 and regional event directors 40) have access to all pages of the vetting portal 200, 1400. In some embodiments, various administrators 40 can only access certain pages. For example, event coordinators 40 only being able to access to the my events 1440 and event photos 1600 pages.

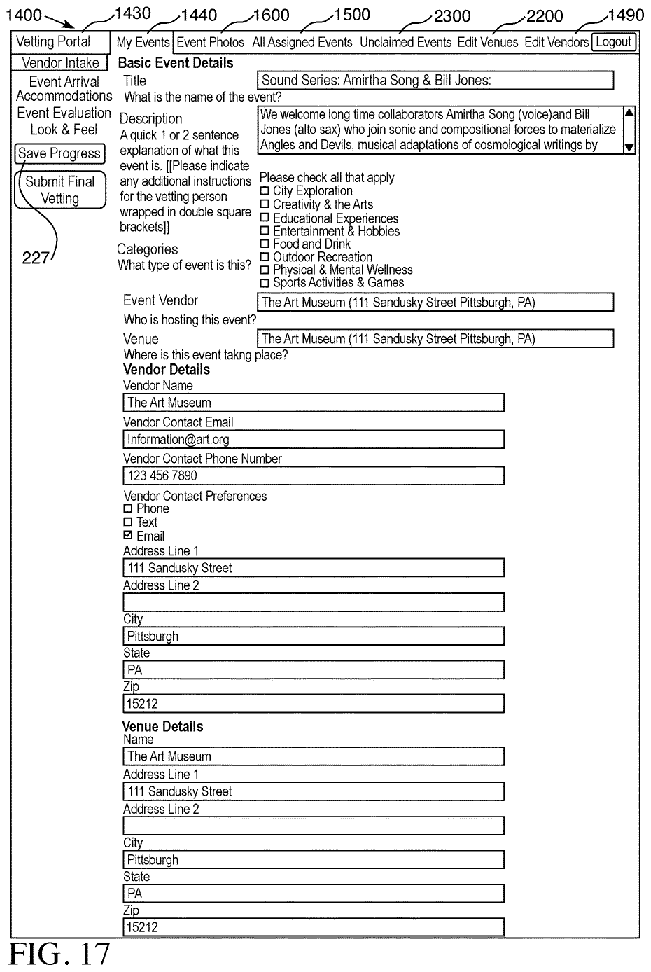

On one embodiment of the my events page 1440 (FIG. 14), an administrator 40 can view the events 256 that have been assigned to them to vet, and any of their previously vetted events 252. Solutions specialists 40 and regional event directors 40 can view all previously vetted events 252. Search boxes for both sections allow a user 40 to search for specific events 252, 256. Clicking on any of the events 252, 256 on the my events 240 page will open the vet/edit event form 207 (FIG. 2), comprised of at least one set of questions (example questions shown in FIGS. 17 through 21). The vet/edit event form 207 can includes all of the specific embodiments illustrated in FIGS. 17 through 21, a subset of those questions/embodiments, and/or other questions that may be relevant to other types of events 252. Each of those specific embodiments can be configured to be an individual tab on the vet/edit event form 207 or they can be combined into fewer tabs. Depending on the current phase of regional implementation and type of vendor 50, the vet/edit event form 207 can be simplified or made more detailed. In some embodiments of the present invention, the vetting version of the form can be configured with a save progress button 227 (FIG. 17), allowing an administrator 40 the ability to complete the form 207 fully at their leisure. If editing a previously vetted event 252 or continuing a saved to-be-vetted event 256, any information previously saved to the staging region database 210 (FIG. 2) can be prefilled 220, 222, 226. On form submission, all information is saved into the staging region database 210 (FIG. 2). Various embodiments of the present invention can be used to enter a wide variety of information that can be relevant to a user 10 who is evaluating whether to attend an event 252 and to facilitate a user's attendance at an event 252. Some nonlimiting examples are detailed in FIGS. 17 through 21. Additional fields can include information on getting to the event 252 (such as directions), parking information, dress code, venue atmosphere, venue accommodations and accessibility, food options, and seating options,

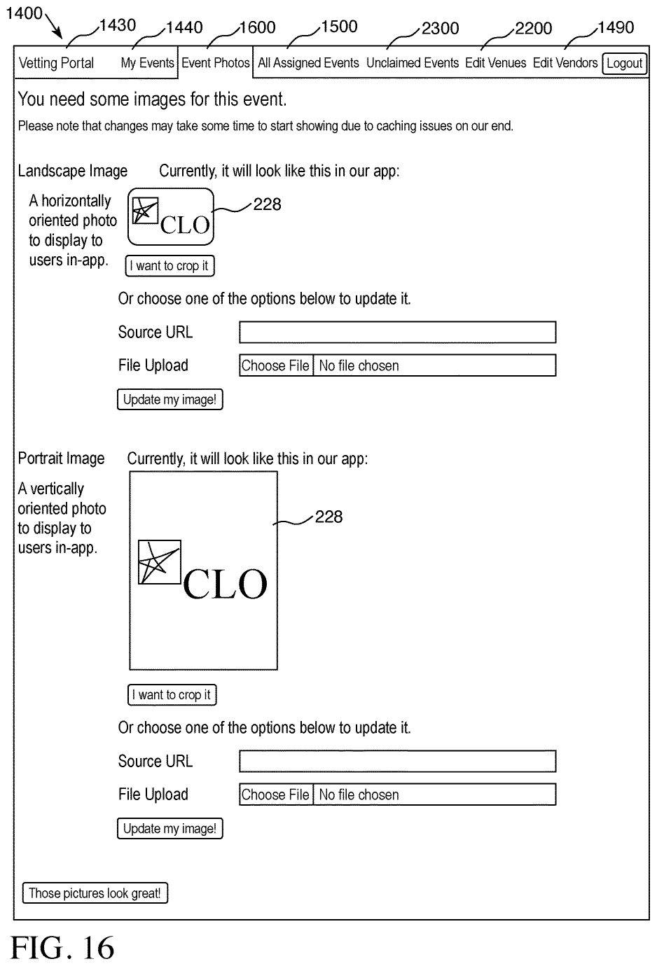

In one embodiment of the event photos page 1600 (FIG. 16), administrators 40 are shown similar sections to those available on the my events page 1440, with the same user access restrictions and search functionalities. Clicking on an event 252, 256 on this page will open the add/edit event photo form 206 (FIG. 2). Events to be vetted 256 will open a blank form while previously vetted events 252 will open the form prefilled with that event's photo 228 (FIGS. 2 and 16). The blank form can be configured to upload, edit, and/or update photos 228 for an event 252, 256. Both forms function similarly and can be configured with features cropping tools for both landscape and portrait image uploads. Optionally, the forms can display for the administrator 40 how the photo 228 will look on the app or website (see FIG. 16). On form submission, all information is saved into the staging region database 210 (FIG. 2).

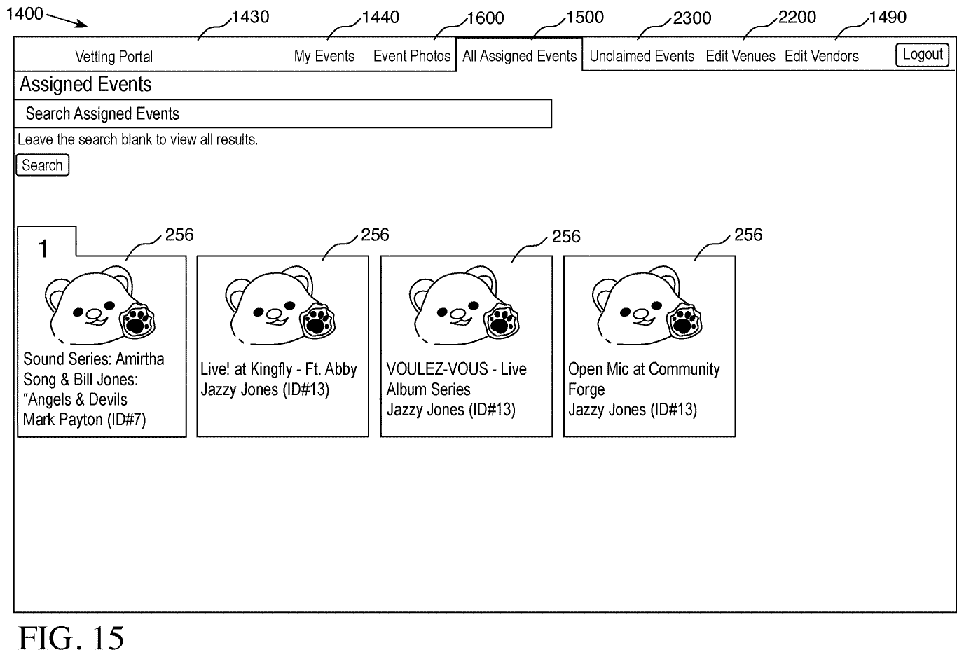

One embodiment of the all assigned events page 1500 (FIG. 15) lists all the events 256 that currently are assigned to administrators 40 (such as event coordinators) to vet. An administrator 40 (such as a solutions specialist 40 or regional event director 40) can then click on an assignment to open the unassign event vetting form 205 (FIG. 2). This form 205 lists basic event details 108 and allows the administrator 40 to remove that event vetting assignment. Nonlimiting examples of details 108 that can be included on this form are the event vendor, the title of the event, a description of the event, the venue, and an assigned vetting time.

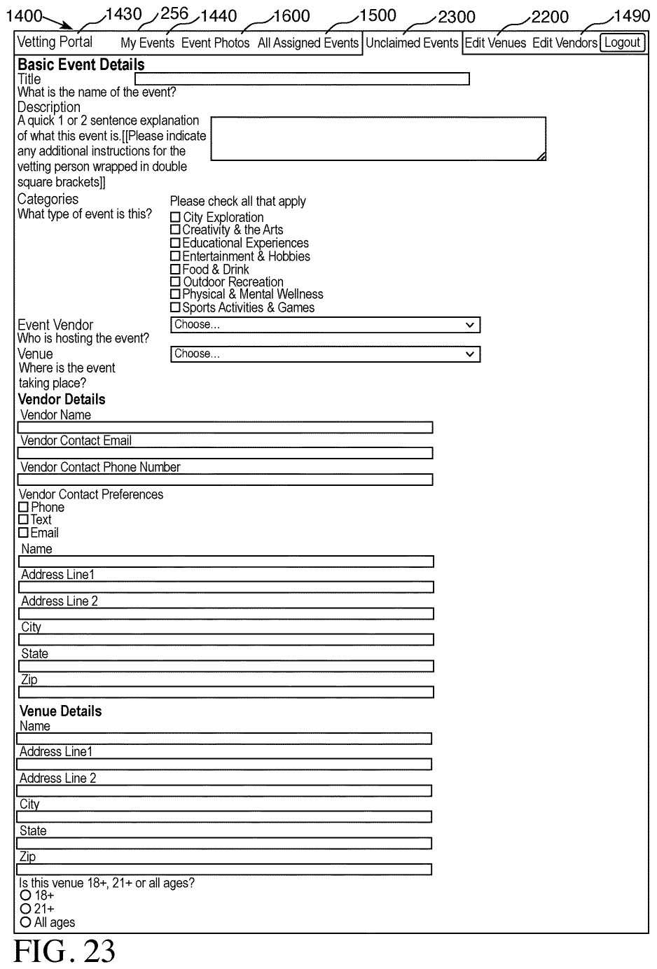

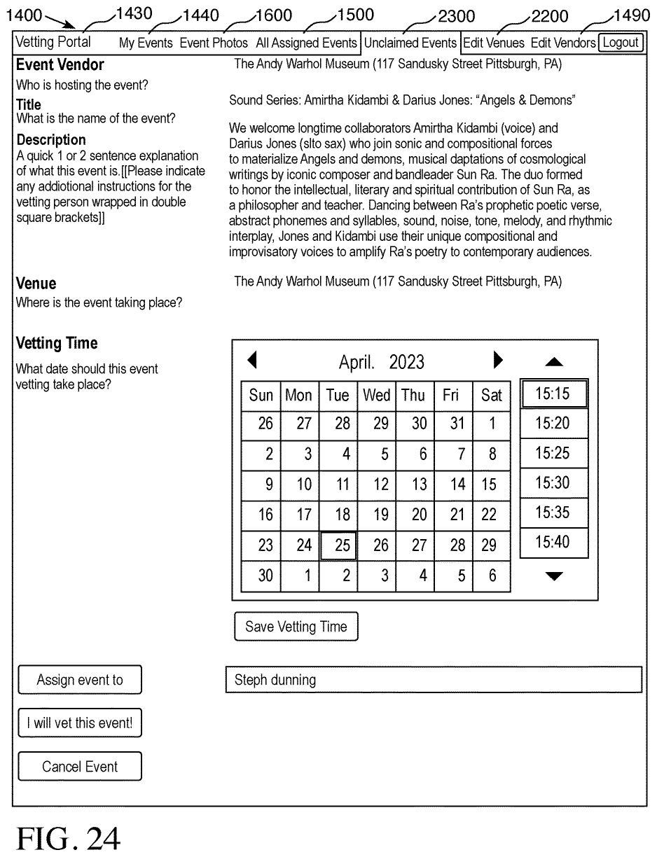

Two embodiments of an unclaimed events page 2300 (FIGS. 23 and 24) lists events 256 that have been created that need vetted but are currently not assigned to a particular administrator 40 (like an event coordinator 40) to vet. One embodiment of this unclaimed events page 2300 can be configured with a search box to search through those events 256. Additionally, it can be configured with a button to create a new event to be vetted 256, which takes administrators 40 to the new unvetted event form 203 (FIG. 2). These events 256 to be created can be found through manual research by an administrator 40 (such as a solutions specialist 40 or a regional event director 40) with some information attained through other means, such as webscraping public review data. Clicking on one of the unassigned events 256 will take administrators 40 to the assign event vetting form 204 (FIG. 2). The assign event form 204 allows an administrator 40 (such as a solutions specialist 40 or regional event director 40) to create a vetting assignment for another administrator 40 (such as an event coordinator 40).

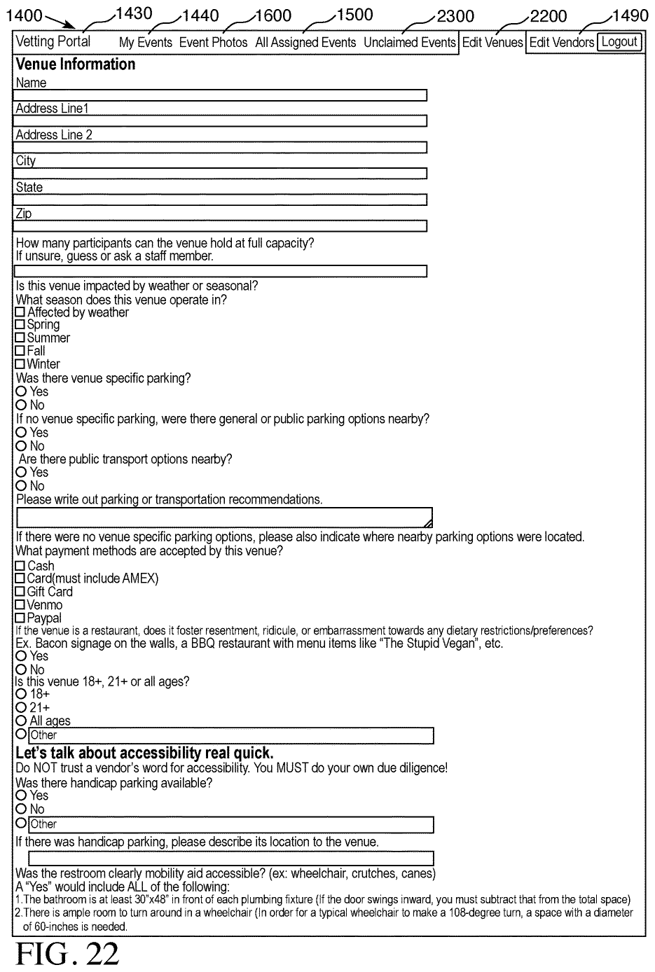

One embodiment of the edit venues page (as part of the system in FIG. 2 at 280 and as one embodiment in FIG. 22 at 2200) lists all records of venues 116 and allows an administrator 40 (such as a solutions specialist 40 or regional event director 40) to edit existing venues 116 or create new records for venues 116 with the new/edit venue form 208 (FIG. 2).

One embodiment of the edit vendors page 1490 can be configured to list all vendor records 116 and allows an administrator 40 (such as a solutions specialist 40 or regional event director 40) to edit existing vendors 116 or create new vendor records 116 with the new/edit vendor form 209 (FIG. 2). Example fields on the vendor information page 209 can include the vendor name, email address, phone number, contact preference, address, and point person, among other fields.

### Event Catalog Data Flow 800

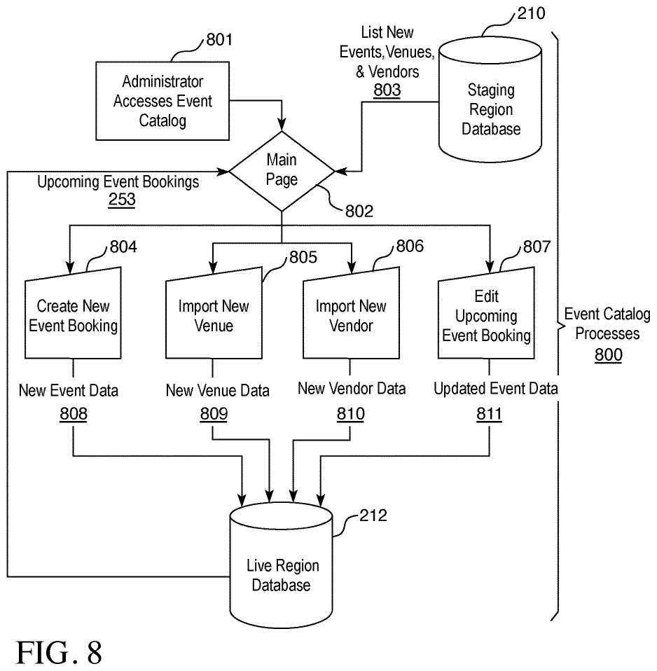

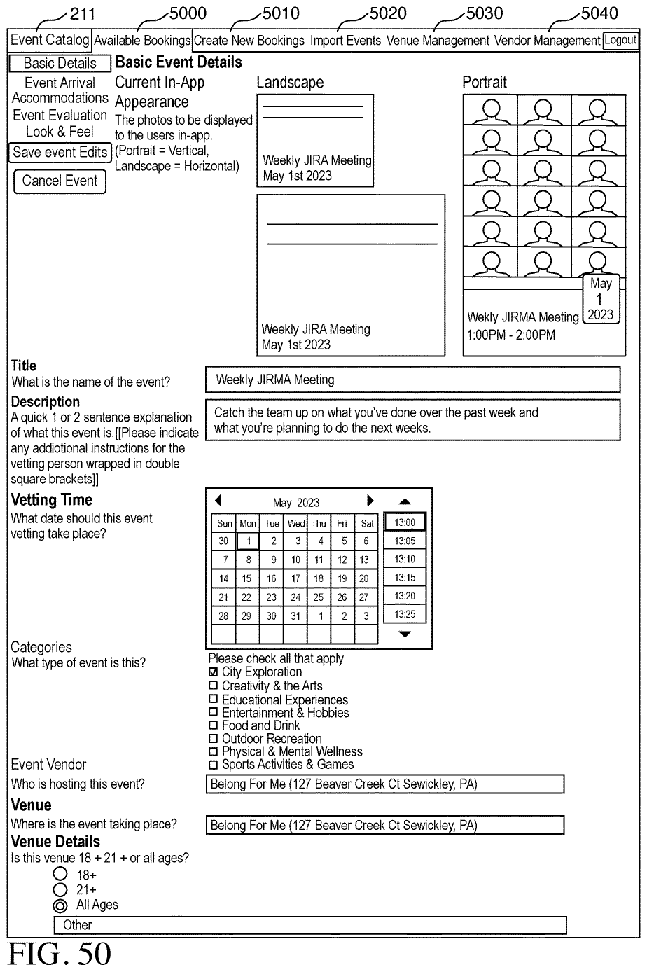

One embodiment of an event catalog data flow or processes 800 according to the present invention is illustrated in FIG. 8. For this embodiment, an administrator 40 logs into the event catalog 801. An administrator 40 in this context can be a solutions specialist 40 or a regional event director 40. Once logged in, the administrator 40 can be directed to the available bookings page 5000. One embodiment of that page can be configured to have a persistent navigation menu bar at the top of the page that can be used to access other pages that are detailed in FIGS. 8 and 50. Certain administrators 40 (such as solutions specialists 40 and regional event directors 40) have access to all pages of the events catalog 211, 800.

One embodiment of the available bookings page 5000 lists all currently booked events 253. A search box can be available to allow administrators 40 to search through all listings 253. Clicking on a listing 253 on this page will open the edit upcoming booking form 807 (FIG. 8), where the user can edit details of the upcoming event or cancel it.

One embodiment of the create bookings page 5010 (FIG. 50) lists all event templates 254 from the staging region database 210 that can be used to create a new event booking 253. In some embodiments, a search box allows administrators 40 to search for specific events to create new bookings from. Clicking on an event template 254 on this page 5010 opens the create new booking form 804 (FIG. 8), which allows an administrator 40 to specify a date and time for the new booking 253. On submission, this form 804 flows into the edit upcoming booking form 807, to allow specific booking details to be changed if required. An administrator 40 also can import a new venue 805 and the new venue data 809 is sent to update the live region database 212. Similarly, an administrator 40 can import a new vendor 806 and the new vendor data 810 is sent to update the live region database 212. Finally, the administrator 40 can edit an upcoming event booking 807 and the updated event data 811 is sent to update the live region database 212. All of the data is used to populate upcoming event bookings 253 that are displayed on the event catalog main page 802.

One embodiment of the import events page 5020 lists all the event templates 254 from the staging region database 210 that currently cannot be used to create event bookings 253, for any number of reasons. Clicking on one of these event templates 254 will open a message (FIG. 49) indicating what an administrator 40 must do to be able to use the template 254 to create a booking 253. These issues range from a missing vendor or venue, to missing event photos.

One embodiment of the venue management page 5040 allows administrators 40 to import venue information 803 from the staging region database 210 (FIG. 8) into the live region database 212, allowing it to be used in reference to event bookings 253. The vendor management page 5030 allows administrators 40 to import vendor information from the staging region database 210 into the live region database 212 (see FIG. 8), allowing it to be used in reference to event bookings 253.

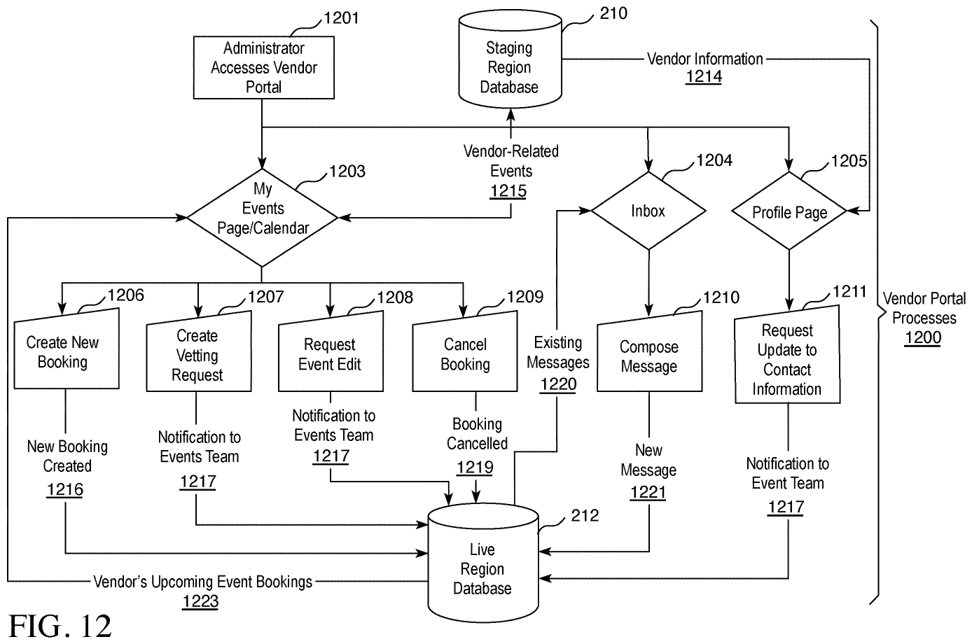

Vendor Portal Data Flow and Processes 1200 For various embodiments of the present invention, an administrator 40 logs into the vendor portal 1201 (FIG. 12). An administrator 40 in this context is a representative from a partnered vendor who has been authorized to work within the systems 900, methods 6000, and storage media 7000 of the present invention. Not all vendors 50 have direct access to the vendor portal 1200. Once logged in, the administrator 40 can be, by-default, shown the my events page 1203, with an optional persistent navigation menu bar at the top of the page that can be used to access other pages, including the calendar view 1203, a messages inbox 1204, and a vendor profile page 1205. From the my events page 1203, an administrator 40 can view upcoming bookings, past bookings, event booking edit requests that are pending review, and drafts to event edits (see FIG. 12). Vendor information 1214 can be communicated from the staging region database 210 to the profile page 1205, where administrators 40 can create new bookings 1206 using parent events from the staging region database 210 (FIG. 12) where they are the assigned vendor 50 (FIG. 12). Administrators 40 can also create requests for the vetting of new events 1207, which are then sent to the appropriate administrator 40 as notifications 1217 (see FIG. 12). Administrators 40 can also request to make edits to 1208, or cancel 1209, their upcoming bookings. Edits can be passed along to the designated administrator 40, 1217 (such as the regional event director) to approve or deny, while cancellations 1219 are applied to the live region database 212 immediately (see FIG. 12).

For various embodiments, a calendar page 1203 lists upcoming bookings and past bookings in a calendar view, with optionally list-by-month and list-by-week views. From this page, an administrator 40 is also able to create new bookings 1206, 1216, request booking edits 1208, 1217, or cancel upcoming bookings 1209, 1219, each in a similar fashion to the my events page 1203 (see FIG. 12).

Additionally shown in FIG. 12, the inbox page 1204 lists all messages that the administrator 40 has received (such as from the events staff 40) regarding any edit requests, vetting suggestions, or direct messages 1220. The page also lists sent messages and message drafts. From this page, an administrator 40 can compose a direct message to other administrators 40 (such as their regional events staff) 1210, 1221. This message can be duplicated and sent through email as well.

The profile page 1205 draws the current vendor contact information associated with the administrator 40 from the staging region database 210 and displays it to the administrator 40. The administrator 40 can then update those fields as an edit request 1211, 1217, which then can be sent as a notification and email to another administrator 40 (such as the regional events team 40) to approve and apply changes or deny (see FIG. 12).

Also illustrated in FIG. 12, vendor-related events 1215 can be communicated between the my events page/calendar 1203 and the staging region database 210. The live region database 212 can communicate a vendor's upcoming event bookings 1223 to the my events page/calendar 1203.

### Application Processes 700

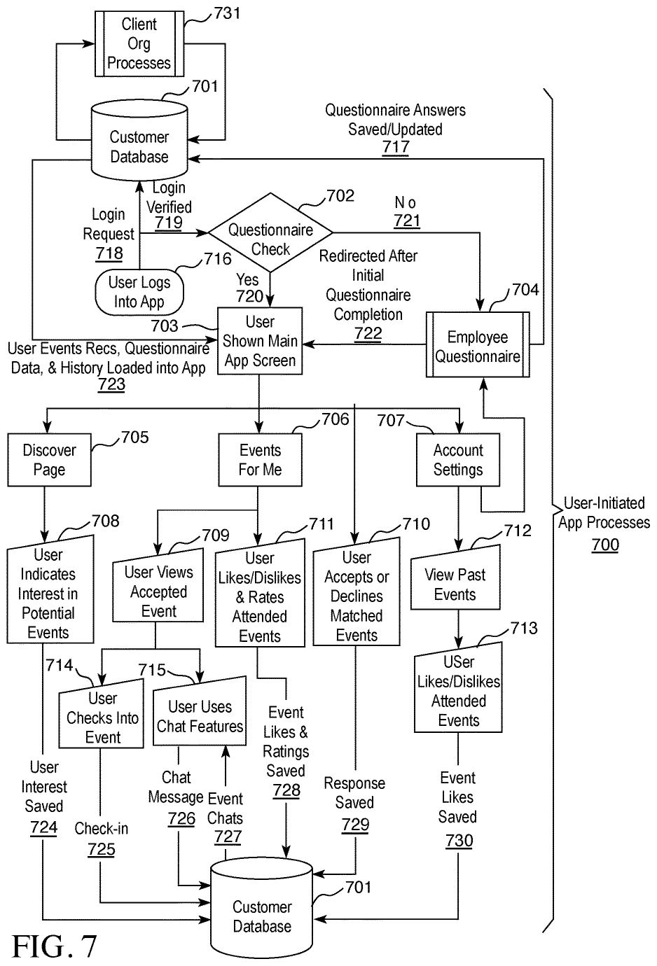

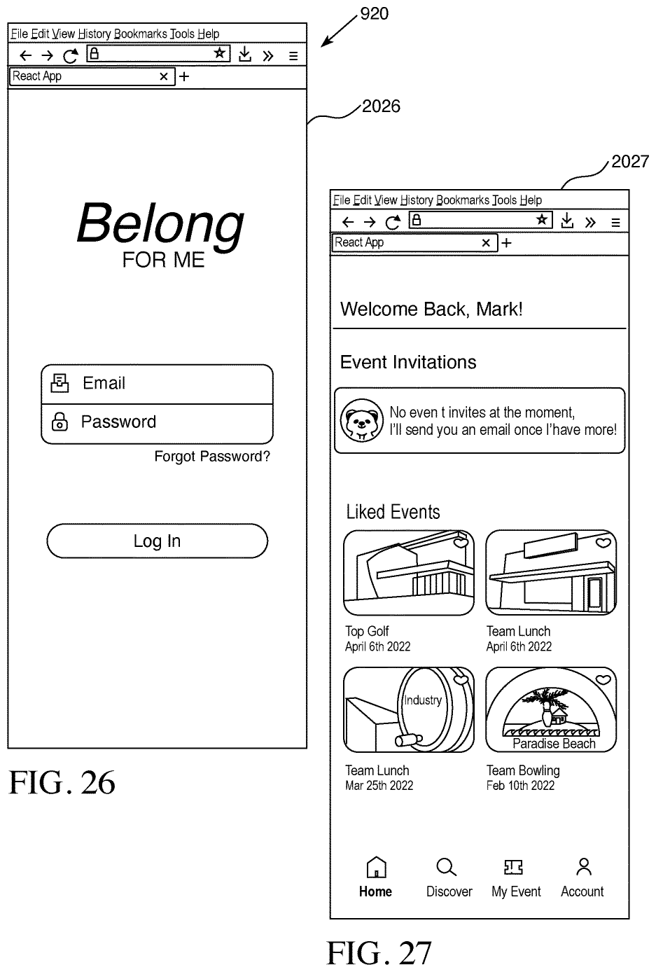

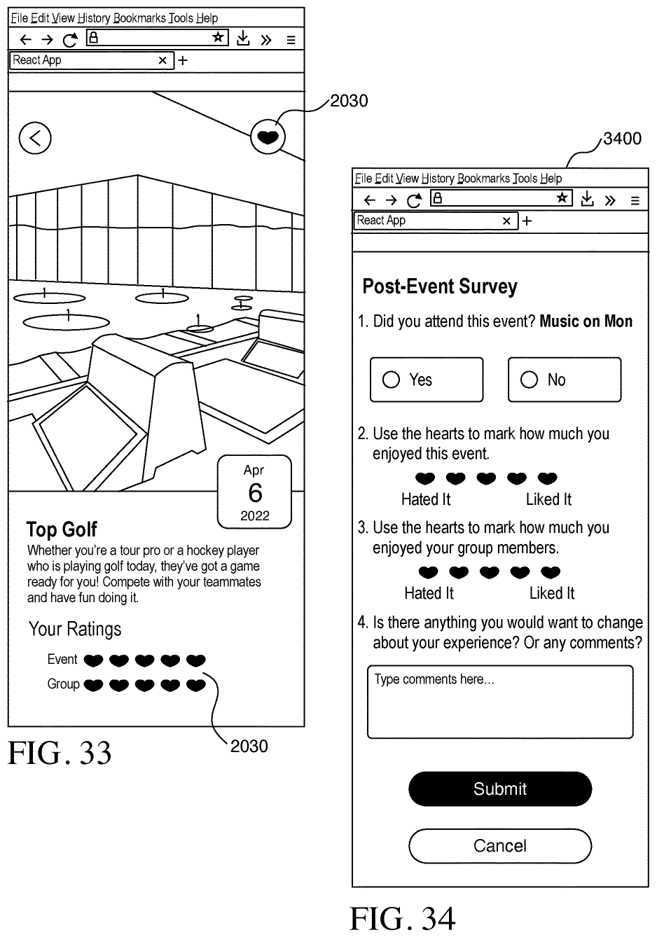

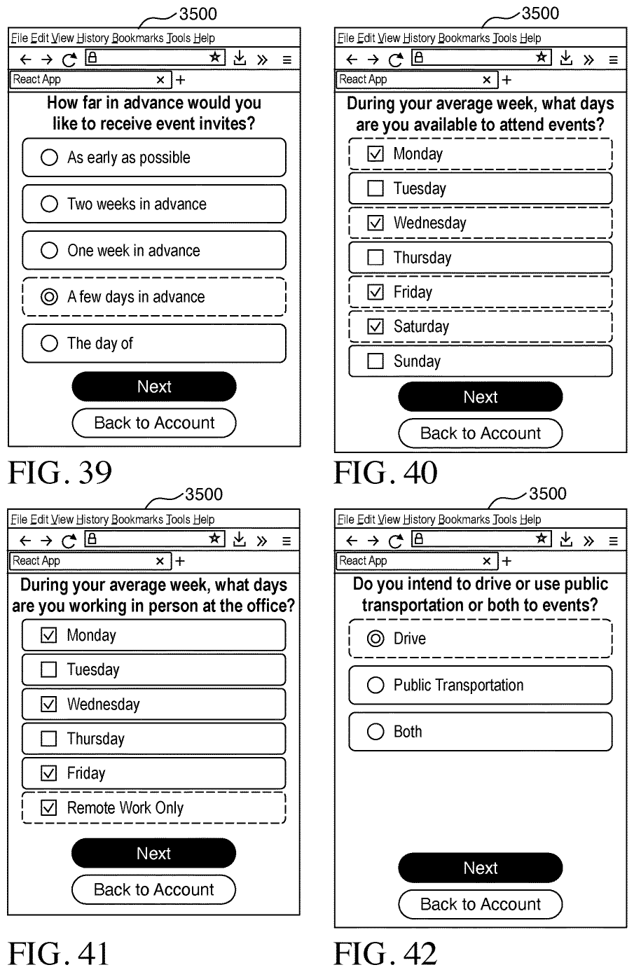

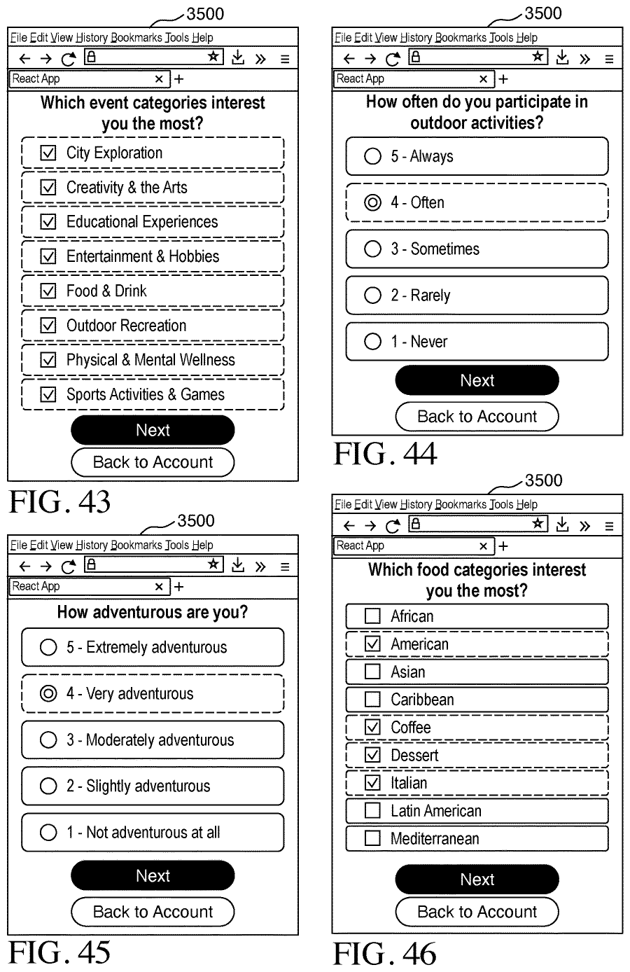

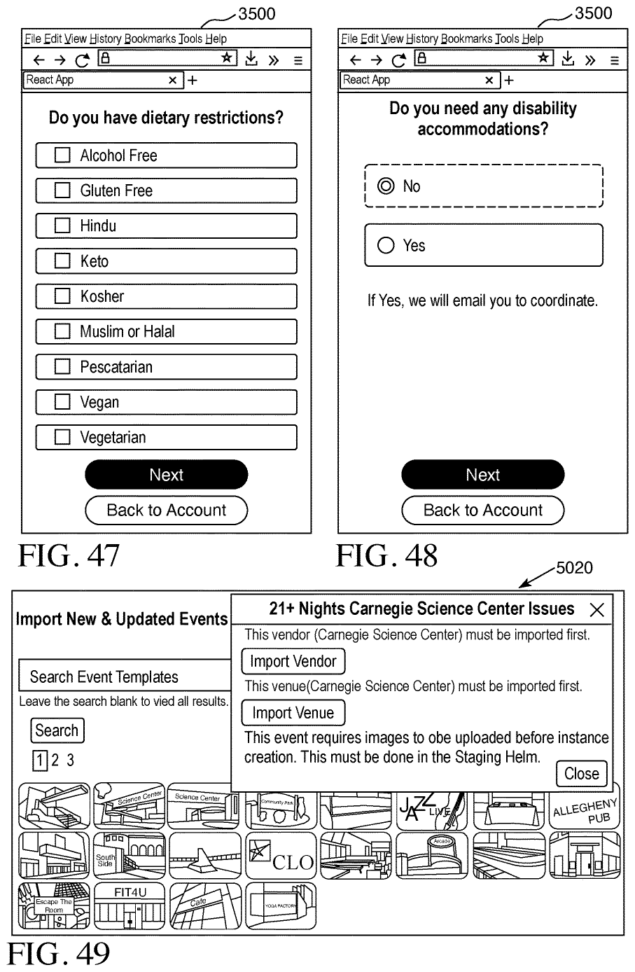

FIG. 7 illustrates several user-initiated app processes 700 according to various embodiments of the present inventions, which are detailed in specific embodiments illustrated in FIGS. 26 through 48 and discussed more fully herein. In some embodiments of the present invention, a user 10 logs into 716 the mobile application 920 via a login screen (one embodiment of a login screen is shown as 2026 in FIG. 26), which sends a login request 718 to the servers 910. The user's account and password are checked against the customer database 701 (FIG. 7).

As shown in FIG. 7, once the login attempt is verified 719, all logins go through a check stage 702 that checks whether this user 10 has completed their onboarding questionnaire 704. If the user 10 has completed it 720, they proceed to the main app screen 703 and 2027 (FIG. 7 generally and a specific embodiment in FIG. 27). If they 10 have not 721, the user 10 is redirected directly to the questionnaire screen 704 (FIG. 7). After the user 10 has completed the initial questionnaire, they 10 can be redirected 722 to the main screen 2027, 703. The user input 102 that has been entered into the employee questionnaire 704 is then saved used to update 717 the customer database 701.

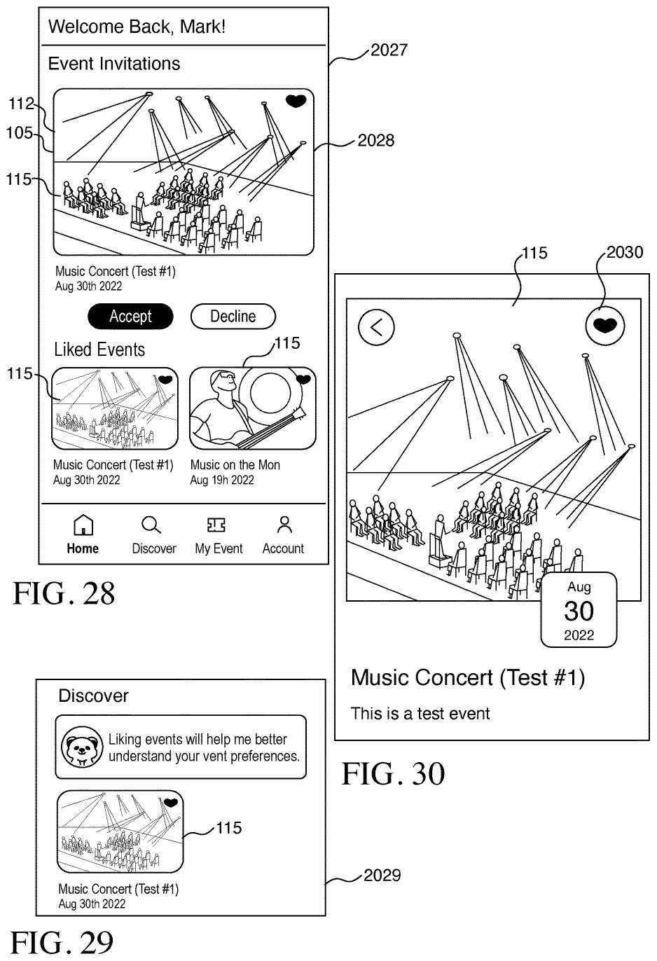

From the main screen 703, 2027, a user 10 has options to navigate to their discover page 705, the user's my events page 706, or their settings page 707 (FIG. 7). Events that have been proposed 2028 to users 10 also will be prominently displayed on the main screen 2027 (generally at FIG. 7 and as a specific embodiment at FIG. 28). Users 10 can then accept or decline the proposed events 710 or select them to view more information. After accepting an event (which indicates an interest in the event 708), users 10 are given the option to add calendar reminders to select various calendar utilities, including Google Calendar, Outlook Calendar, and iCal.

On the discover page 705 and 2029 (generally at FIG. 7 and a specific embodiment at FIGS. 29 and 30), a user 10 will be able to view a rotating group of events 115 that are used to collect interest data 724, that in turn can be used to create a more accurate profile 101 of their likes and dislikes. The vehicle for presenting these events 115 to users is variable and can be a simple list of events or something more interactive, such as a chatbot. While on the page, a user can ‘like’ 2030 shown events and assign an interest rating to them, with some embodiments using a value from 1 to 10, with higher user interest ratings 708 indicating a higher interest in the event 708 (FIGS. 7 and 30). However, other interest rating systems 708 can be used with the present invention and any interest ratings system 708 can be tailored to the types of events 252 that are being evaluated. These likes and interest ratings 708 are then pushed back into the customer database 701 (FIG. 7), where they are then able to be assigned weights and used in the event matching recommender module algorithm 940 to suggest events 251 to the user 10 to actually attend with a group 20. In one preferred embodiment of the present invention, a user's interest 708 in an event 251 is given a higher weight than most other factors.

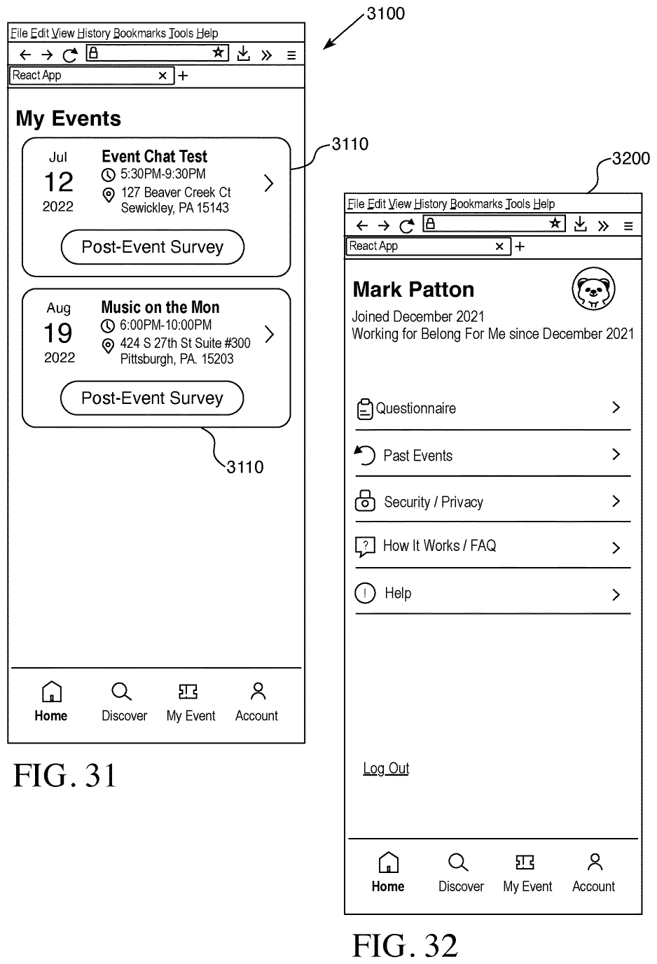

On the events for me or my events page (generally shown in FIG. 7 at 706 and a specific embodiment shown in FIG. 31 at 3100), a user 10 is shown the curated events 115 that have been proposed for them to attend, as well as their previously attended, but not yet rated, events 3110. From this page, a user can view accepted events 709 (FIG. 7) and rate previously attended unrated events 711, 2030 (FIG. 7 and FIGS. 31 and 33). The user's event likes and ratings are saved 728 to the customer database 701. Similarly, when a user accepts or declines matched events 710 those responses are saved 729 to the customer database 701. When the user likes or dislikes past attended events 713 those responses are saved 730 to the customer database 701. The customer database 701 also is used to provide information to the client organization processes 731.

While viewing currently accepted events from the events for me page, a user also has additional options, including the ability to view other confirmed attendees, check into the event 714 (indicating they have arrived at the venue) (which is used to update the customer database 725), and using a chat feature 726, 727 to communicate with other attendees 715 (FIG. 7). In one preferred embodiment of the present invention systems 900, the event details 108 generated to the at least one user 10 for an event accepted 250 by the at least one user 10 include other users 10 who have accepted the event 250.

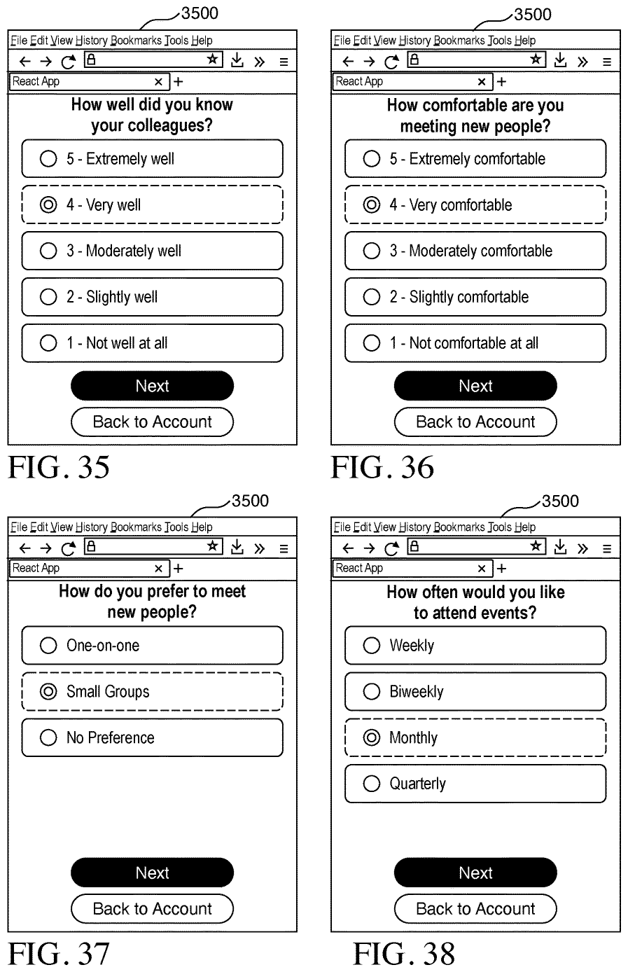

The settings page (shown generally in FIG. 7 at 707 and a specific embodiment in FIG. 32 at 3200) can be configured to contain a variety of account-related pages including, but not limited to, a support contact page, a helpful links page, and a link to a main webpage's FAQs. It also contains the employee preference questionnaire 704 (FIG. 7), so that a user 10 may access it 704 at any time and update their preferences. Examples of questions that can be included in the Post-Event Survey 3400 and/or the employee preference questionnaire 704, 3500 are illustrated in FIGS. 34 through 48. FIG. 34 illustrates one embodiment of a post event survey. FIGS. 35 through 48 illustrate a nonlimiting variety of questions for the initial user questionnaire. These answers serve as weighted parameters inside the recommendation module algorithms, allowing users some direct control over how their personalized recommendations are selected.

The settings page 707 also contains a view of a user's previous event history 712 (FIG. 7 and FIG. 32 at 3200). From this view, a user can view how they have rated past events 713 (FIGS. 7 and 32), as well as apply likes or remove likes from those events 713 (FIG. 7). All or a subset of the user event recommendations 251, user input 102 from the questionnaire 704, user data 110, and any history can be loaded into the app 920, 723 to be displayed on the user's main app screen 720.

### Automated Processes 600

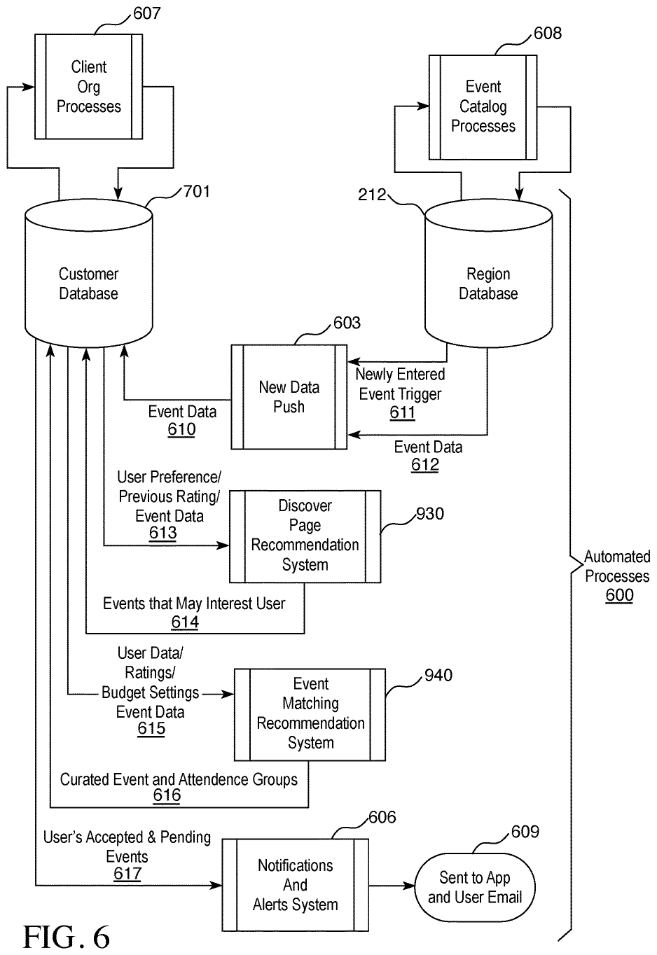

FIG. 6 illustrates one set of automated processes 600 according to one embodiment of the present invention. This set of automated processes 600 is discussed below as example processes and not an exhaustive list of processes that can be incorporated into the present invention. There are multiple automated processes that occur within the standard operating application and servers of the present invention, including but not limited to: (a) region-to-customer data pushes 603; (b) discover page recommendation module 930; (c) event match recommendation module 940; and (d) notification and alerts system 606.

In one embodiment of the present invention, when an event record is created or updated 608 on a live region database 212, the system then triggers pushes 610, 611, 612 to all associated customer databases 701 (see FIG. 6). These pushes initiate a data fetch from the region database 212 to the customer database 701, passing all live event record data 610, 611, 612, including event instance data, venue data, vendor data, and address data. The fetched data is iterated through, being passed to stored procedures in the customer database 701, to update existing records or create new records on the customer database 701. This ensures that each customer database 701 should always maintain the most up-to-date event record data 610. Additional details are discussed below.

Region-to-Customer Data Push 603 (FIG. 6): In one embodiment of the present invention, when an event record is created or updated 608 on a live region database 212, the system then triggers pushes to all associated customer databases 701 (see FIG. 6). In this embodiment, these pushes initiate a data fetch from the region database 212 to the customer database 701, passing all live event record data 610, 611, 612, including event instance data, venue data, vendor data, and address data. The fetched data is iterated through, being passed to stored procedures in the customer database 701, to update existing records or create new records on the customer database 701 and the data moves through the client organization processes 607 (see FIG. 6). This ensures that each customer database 701 should always maintain the most up-to-date event record data.

Discover Page Recommendation module 930 (FIG. 6): In one embodiment of the present invention shown in FIG. 6, and optionally on a regular schedule, all users' discover pages 705, 2900 can be refreshed with new personalized recommendations from the discover page recommender module (“DP Recsys”) 930. The DP Recsys 930 pulls event records, previous event interest ratings 708, event likes, and user questionnaire summaries 613 from the customer database 701. Using machine learning algorithms to analyze all available data, the DP Recsys 930 determines a set of new discover page events that it believes best matches each users' interests 614. The new sets of events 614 are pushed back into the customer database 701, to be added to the users' records. The new set of events 614 will then be propagated to the discover page for the user to view and rate.

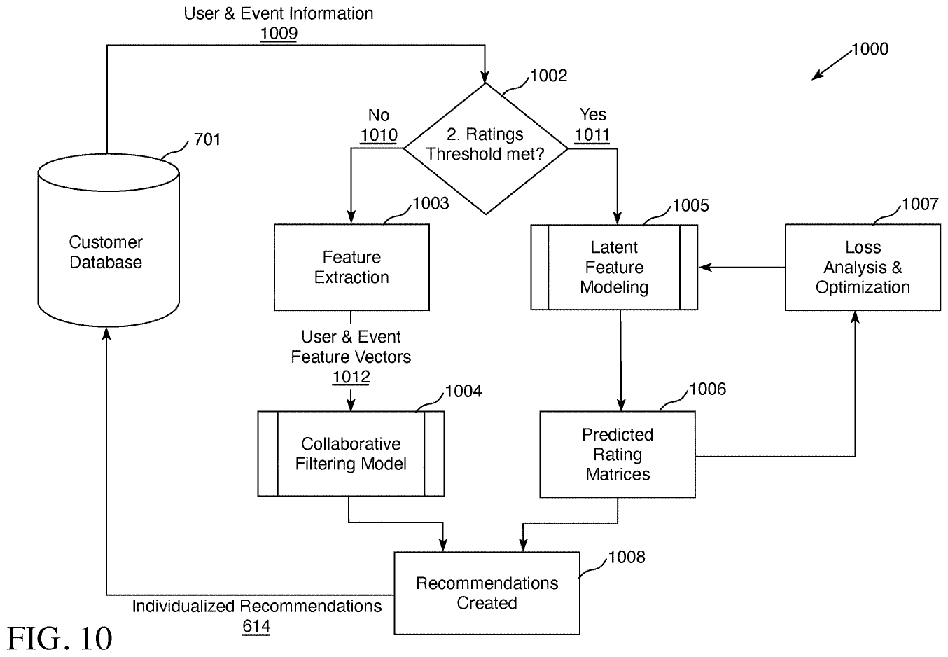

In one embodiment of the present invention, when periodically scheduled or triggered to run, the discover page recommender module 930 will draw and event information from a given customer database 701 and process it according to the individualized recommendation processes 1000 illustrated in FIG. 10. The user and/or event information 1009 is then analyzed to determine if a particular ratings threshold has been met 1002, which determines which recommendation method is used (see FIG. 10). This threshold is analogous to the number of events a user 10 has rated after attending or rated their interest in through the discover page 705, 2900. If the threshold is not met 1010, a collaborative filtering approach 1004 is used, as discussed more fully below. If the threshold is met 1011, a latent matrix factorization 1005 approach is used, as discussed below. This dual approach helps to alleviate the cold-start issues that can arise due to lack of pertinent data. In this one preferred embodiment of systems 900 of the present invention, the process for generating personalized recommended events 251 can be selected based upon whether a predetermined user ratings 711 threshold is met, and with the user ratings 711 threshold analogous to the number of events that the at least one user 10 has rated before attending an event 252. In other embodiments of the invention, other data processing tools and models can be used to generate recommendations that are fed back 614 into the relevant customer database 701.

If the ratings threshold is not met, the discover page recommender module 930 will then perform feature extraction 1003 (FIG. 10) on the full user profiles, to create feature vectors for all users 10. Feature extraction 1003 is a standard process of taking an entire dataset and reducing and transforming it into a smaller subset of datapoints, which are usable in later data processing, while preserving the information provided by the original dataset. For example, critical steps of feature extraction 1003 include the transformation of non-numerical datapoints into numerical data, such as transforming the categorical text variables of a user's chosen set of event categories 117 into a set of binary variables, or the normalization of data that exists in ranges across various users' datasets, such as user interest ratings. Feature vectors are those smaller data subsets. All available data tracked for a user 10, including but not limited to event ratings, group ratings, interest ratings, questionnaire preferences, segmentations applied by their employer, budgetary information, employment hierarchy, applicable address information, and any other event restrictions requested by an employer 30, can be used during the creation of a user's feature vector. All use feature vectors, regardless of individual user, have the same structure and composition of data fields. For example, a very simple user feature vector may take the form of (5, 4, 1, . . . , 4, 2), where each number corresponds to a feature, such as the rating of an individual event.

The feature vectors 1012 are then used as inputs for a collaborative filtering algorithm 1004 (FIG. 10). In such a model, an individual user's feature vector 1012 is compared to other users' feature vectors 1012 to find similar users. The algorithm defines that similarity by mapping all user feature vectors 1012 as points into an n-dimensional space, where n is the length of a feature vector 1012, and then mathematically comparing the points to determine a similarity score for each set of points. The base mathematical formulas for determining the similarity score are well known, and the current iteration of the algorithm makes use of Pearson correlation, as well as cosine similarity formulas. Once the pairings of points are compared, the model 1004 can quickly find a number of the most similar users to the user in question. The model then returns a list of events that those similar users rated highly, with the assumption that similar users have similar event ratings. These events are then compiled into event recommendations 1008, mapping the user being recommended the event with the event itself, and sent back 614 into the relevant customer database 701 (FIG. 10).

Assuming the ratings threshold is met 1011, the discover page recommender module 930 currently utilizes a latent matrix factorization algorithm 1005 in its individualized recommendation processes 1000 (see FIG. 10). In such a model 1005, the users' event ratings are used to create ratings matrices (predicted rating matrices 1006), which simply chart each user 10 and each event 252, and their corresponding ratings 1005. Using this chart, the algorithm performs matrix factorization to create latent feature matrices and associated weights, which when multiplied together create the original ratings, as well as the predicted ratings 1006. The generated ratings are then tested and analyzed through a loss function 1007 to determine how accurate they are, and the associated weights are optimized through a modified stochastic gradient descent algorithm 1007. The optimized feature matrices and weights are then fed back into the model, and the process is repeated until the loss generated by the loss function testing is acceptable. At that point, the latent rating matrix is used to select a number of events with the highest predicted ratings for a user, which are then compiled into event recommendations 1008 for that user and those recommendations are fed back 614 into the relevant customer database 701.

The one embodiment of the present invention, systems 900 are configured such that the process for generating new personalized recommended events 251, after the at least one user 10 has attended one or more events 251, is selected based upon whether a predetermined user ratings threshold is met, and with the user ratings threshold analogous to the number of events that the at least one user 10 has rated before or after attending an event. This is illustrated in FIG. 7, which shows how the user indicates interest at steps 708, 709, 711, 710 and 713

Event Match Recommendation Module 940 (see FIG. 6): In one embodiment of the present invention, on a regular schedule, all users 10 can receive a new set of event recommendations 616, which include the event itself that best matches an individual user's interest, as well as an accompanying attendance group, with whom they have shared interests, from the event matching recommender module (“EM Recsys”) 940 (see FIG. 6). The EM Recsys 940 pulls user preference data, user ratings data 708, budget data, and event data 615 from the customer database 701. Using a machine learning algorithm to analyze all available data, the EM Recsys 940 determines a set of new event and group matches that it believes best match a user's interests 616. This new set of event-group matches 616 are pushed back to the customer database 701 and applied to the user's record. These new matchings will be pushed to the application for the user to review and either accept or decline.

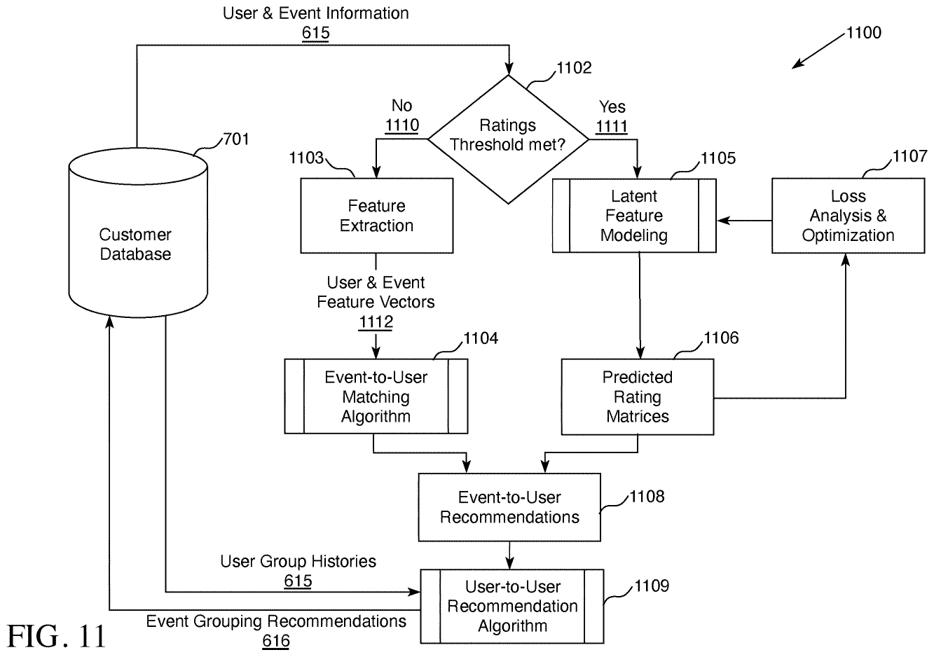

In one embodiment of the present invention, when periodically scheduled or triggered to run, the event matching recommender module 940 will draw user and event information 615 from a given customer database 701 as part of the personalized event-group match process 1100 illustrated in FIG. 11. The user information 615 is then analyzed to determine if a particular ratings threshold has been met 1102, which determines which recommendation method is used 1102. This threshold is analogous to the number of events a user has rated after attending or rated their interest in through the discover page. If the threshold is not reached 1110, a collaborative filtering approach 1103 is used. If the threshold is met 1111, a latent matrix factorization approach 1105 is used. This dual approach helps to alleviate the cold-start issues that can arise due to lack of pertinent data. Again, in other embodiments of the invention, other recommendation methods, tools and models can be used to generate recommendations.

If the ratings threshold has not been met, the event matching recommender module will then perform a similar feature extraction process 1103 to what takes place in the DP Recsys 930 (see FIGS. 10 and 11); however, the event matching recommender module 940 creates features vectors 1112 for not just the users, but for the events as well. The feature vectors 1112 then are used as inputs for the event-to-user matching algorithm 1104. This algorithm 1104 uses a hybrid collaborative filtering/content-based filtering approach. To directly find events that align with a user's interests, a content-based filtering method is used, where the user's feature vector is compared to event feature vectors using a modified dot product approach. This approach results in a similarity score reflecting how close a given event is to a user's indicated preferences, with a higher score indicating a closer ‘fit’ to their preferences. After performing the content-based filtering approach on events, the algorithm will select a given number of events with the highest similarity scores to provide as predictions for events that user will enjoy and rate highly.

Operating with the premise that similar users 10 enjoy similar events 252, the algorithm also employs a collaborative filtering approach as well. Similar to the DP Recsys algorithm, this approach compares users to users using their feature vectors, assigning a similarity score based on Pearson correlation and a modified cosine similarity formula. With the similar users identified, the algorithm can find events 252 that those users 10 have rated highly and use them as predictions for events 252 that the user 10 in question will enjoy and rate highly. Using both sets of predictions, the algorithm can then compile those predicted events and the user information into event-to-user recommendations 1108.

If the ratings threshold has been met 1111, the event matching recommender module 940 will instead use a latent matrix factorization model 1105 to determine event-to-user recommendations 1108 (see FIG. 11). In such a model 1105, the users' event ratings are used to create ratings matrices, which simply chart each user 10 and each event 252, and their corresponding ratings 1105. Using this chart, the algorithm performs matrix factorization to create latent feature matrices and associated weights, which when multiplied together create the original ratings, as well as the predicted ratings 1106. The generated ratings are then tested and analyzed through a loss function to determine how accurate they are, and the associated weights are optimized through a modified stochastic gradient descent algorithm 1107. The optimized feature matrices and weights are then fed back into the model, and the process is repeated until the loss generated by the loss function testing is acceptable. At that point, the latent rating matrix is used to select a number of events with the highest predicted ratings for a user, which are then compiled into event-to-user recommendations for that user 1108.

Using the event-to-user recommendations 1108, as well as historical user group information from the customer database 701, the user-to-user recommendation algorithm 1109 will find match groups 20 of users 10 together, prioritizing creating groups 20 of users 10 that have had few interactions with each other in the past, with the intention of creating larger social and professional networks within their associated customer's ecosystem (see FIG. 11). This algorithm is also a latent matrix factorization algorithm and operates fundamentally the same as those previously explained. However, instead of creating the original matrix using user/event ratings, it is created using the user/user group ratings that are gathered during the post-event surveys. Due to the sparseness of this matrix for a new client organization's userbase, and for individual new users, this algorithm also incorporates a content-based filtering approach as a secondary method to find compatible users. It operates much the same as the previously explained content-based approach, where in the algorithm compares user feature vectors with other use feature vectors, and groups similar users together. Once created, these user-to-user groupings and event-to-user recommendations are compiled into event grouping recommendations 616 and are sent back to the relevant customer database 701.

The event matching recommender module 940 also has the capacity for customer organizations to dictate specific events to be used to create event grouping recommendations 616. The recommender module 940 uses the predetermined event from the customer organization 30 in lieu of the event-to-user recommendations 1108, and instead starts at the user-to-user recommendation algorithm 1109 (see FIG. 11). The same previous interaction weighting model is used to create groups with fewer previous interactions as in the recommender's standard operation. These user-to-user recommendations 1109 are then compiled into event groupings 616, which are then updated back into the relevant customer database 701 (see FIG. 11).

Notification And Alerts System 606 (see FIG. 6): Various actions will occur within the systems and methods of various embodiments of the present invention that require certain notifications be sent out to users 10. One illustration of this is in FIG. 6, wherein the user's accepted and pending events 617 are fed from the customer database 701 to the notifications and alerts system 606. Other non-limiting examples of individual notifications 609 are listed below, alongside their criteria and trigger conditions:

Welcome email 609: In some embodiments of the present invention, when the automated import process creates a new record, a welcome email is sent to that new user's email address, with instructions on how to log into and claim their personal account withing the systems and methods of the present invention.

Account confirmation: In some embodiments of the present invention, this is triggered when the employee 10 completes the account claiming process. The account confirmation sends a thank-you email and a link to the mobile application 609.

Event cancelled: In some embodiments of the present invention, whenever an event is marked as cancelled from the event catalog, any users 10 who have accepted an invite to that event are sent a notification 609 that it has been cancelled. This notification also can be triggered from the matching helm 950 if a user 10 was manually removed from an event that had already been accepted.

Calendar invite: In some embodiments of the present invention, when a user accepts an event invite in the application, a thank-you email 609 is sent to them, which includes various calendar-architecture reminders, including Outlook®, iCal®, and Google® Calendar integrations.

Day-before-event reminder: In some embodiments of the present invention, this reminder is triggered by a daily cronjob. This sends reminders 609 a day in advance for all accepted events of a user.

Welcome Reminder: In some embodiments of the present invention, this reminder is triggered by a regularly occurring cronjob. This reminder 609 is sent to any user who received the Welcome Email more than a week ago (or any preset time) and has not yet claimed their account.

Account Inactive: In some embodiments of the present invention, this notification 609 is triggered by a regularly occurring cronjob 409. This reminder 609 is sent to any user 10 who has not used the mobile application 920 (or received this reminder) in the past month.

Event invite follow-up: In some embodiments of the present invention, this notification 609 is triggered by a regularly occurring cronjob 409. This reminder 609 is sent to any user 10 who received an event invite 112 within the past 2 days (or any preset time) but has not responded to it yet.

Event survey reminder: In some embodiments of the present invention, this reminder 609 is triggered by a regularly occurring cronjob 409. This reminder 609 is sent to any user 10 who attended an event but has not yet completed the post event survey within 2 days (or any preset time).

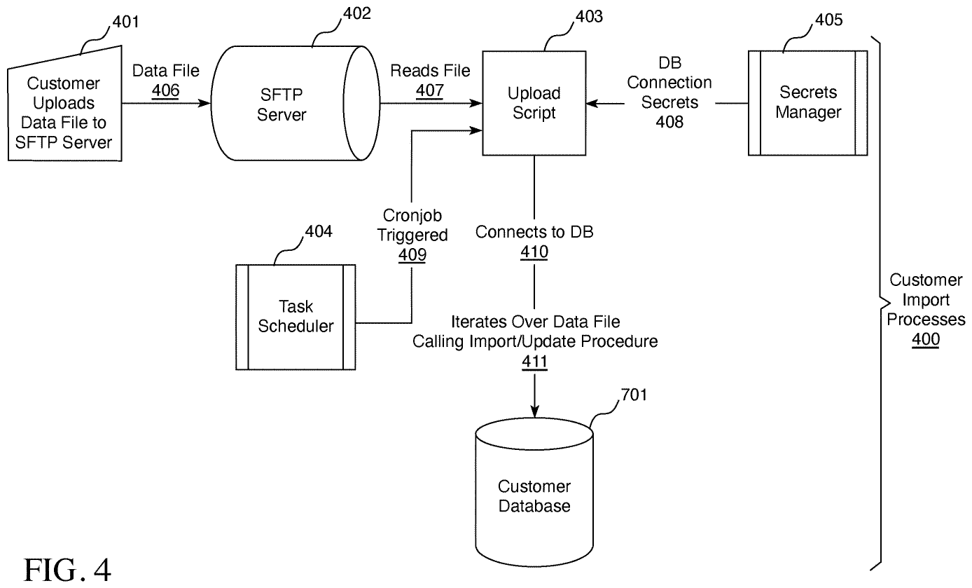

### Customer Data Import Process 400 (FIG. 4)

FIG. 4 illustrates one embodiment of a customer import process 400 according to the various systems and methods of the present invention. For this embodiment, a customer 30 connects to a secure SFTP folder located on the servers 401, 402, 406, 910 (FIG. 4). Other embodiments could allow for direct integration with a customer organization's information systems that house their employee data. The customer 30 uploads a data file 401 consisting of a set of standardized user data fields to that folder located on the server 402, 406. This upload may be an automated process on their end, or a manual process, on any given schedule that they choose. The customer 30 closes SFTP connection. Another option for uploading the user data file 406 is through the Employer Helm 980, which is fully detailed in a following section.

A task scheduler 404 on the server(s) maintains a cronjob 409 that triggers an upload script 403 on a regularly scheduled basis (see FIG. 4). When triggered, the upload script 403 fetches any required connection information (“DB Connection Secrets 408” wherein “DB” is short for “database”) from a cloud-based secrets management service 405, reads the customer's data file 407 from the server's side of the SFTP folder 402, and connects to the customer database 701 (see FIG. 4).

The upload script 403 connects to the database 410 and iterates 411 through the user data file 406, calling an upload procedure on the database with the pertinent arguments from the user data file 406. The upload procedure creates new records when required, or updates existing records for the customer database 701.

During a customer's initial onboarding, the various embodiments of the present invention will also ask a variety of questions pertaining to different parameters that will impact the desired operation of their instance of the present invention's systems and methods. These parameter settings impact how the recommender modules function, database structure, and user experience, among other aspects of the present invention. An example of one of these parameters could include a custom field on their users' records that tracks their alma mater, which would allow the matching algorithms to use that information to create alumni group event recommendations within a customer organization, if so requested.

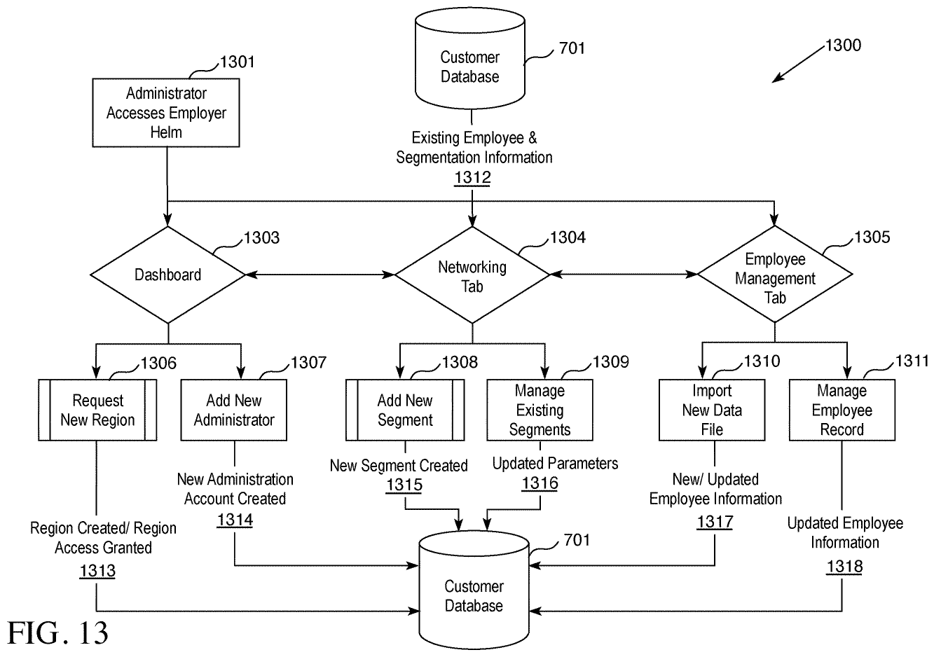

### Employer Helm Processes 1300 (FIG. 13)

FIG. 13 illustrates one embodiment of the employer helm processes and utilities 1300 available to organizations 30 according to the various systems and methods of the present invention. In this embodiment an administrator 40 logs into the employer helm 1301 (see FIG. 13), which draws pertinent employee information 1312 from the customer database 701. An administrator 40 in this context is an administrator 40 employed by or within the customer organization 30.

The landing page for the employer helm is a dashboard 1301, which lists a variety of basic information about the customer organization 30, including but not limited to what region the customer 30 is operating in, a list of administrators 40 at the customer 30 who are charged with or authorized to administer the systems 900, methods 6000, and storage media 7000 of the present invention. From the dashboard 1303, an administrator 40 can also request access to a new region 1306 (see FIG. 13). This request goes to an account manager or an administrator 40, who would then manage the processes of either granting the customer organization 30 access to an existing region or opening a new region 1313. After that process is complete, that region would be added to the customer's database 701 (see FIG. 13). An administrator 40 on the dashboard 1303 can also add a new administrator 40 to the employer helm 1307, which creates a new administration account 1314 in the customer database 701 All pages of the present embodiment of the employer helm 980 can be configured to be connected through a navigation bar, which allows administrators 40 to also access the networking tab 1304 and the employee management tab 1305 (see FIG. 13).

The networking tab 1304 in the current embodiment of the employer helm 980 lists the different segmentations that the customer organization 30 has created (see FIG. 13). The segmentations can be used in the grouping stage of the event matching recommender module 940 to prioritize certain groupings of employees, such as veterans' groups, alumni groups, or other employee resource groups. As a default, each segmentation will have a corresponding budget set, but these defaults can be changed or turned off. Segments are assigned to an administrator in the employer helm 980, who is then responsible for assigning that segment to employees 1309. These updated parameters 1316 are communicated to and used to update the customer database 701 The networking tab 1304 also has an option for an administrator 40 to create a new segment 1308, which creates a new segment 1315 in the customer database 701. The current segmentation system allows subgroups to be created from already existing segments. Any new or updated segmentations are then pushed back into the customer database 701.

The employee management tab 1305 of the current embodiment of the employer helm 980 lists all of a customer organization's employees 10, along with basic details on the employees' records, such as name, email, and access status (see FIG. 13). Selecting a specific employee from the list will open a window detailing more information on that employee's record, with the option to edit 1311 some of that information, such as status or name, with the changes being sent back into the customer database 701. This tab 1305 also contains the manual employee data file upload 1310 that is available to customer organizations. The new and/or updated employee information 1317 and the updated employee information 1318 is used to update the customer database 701.

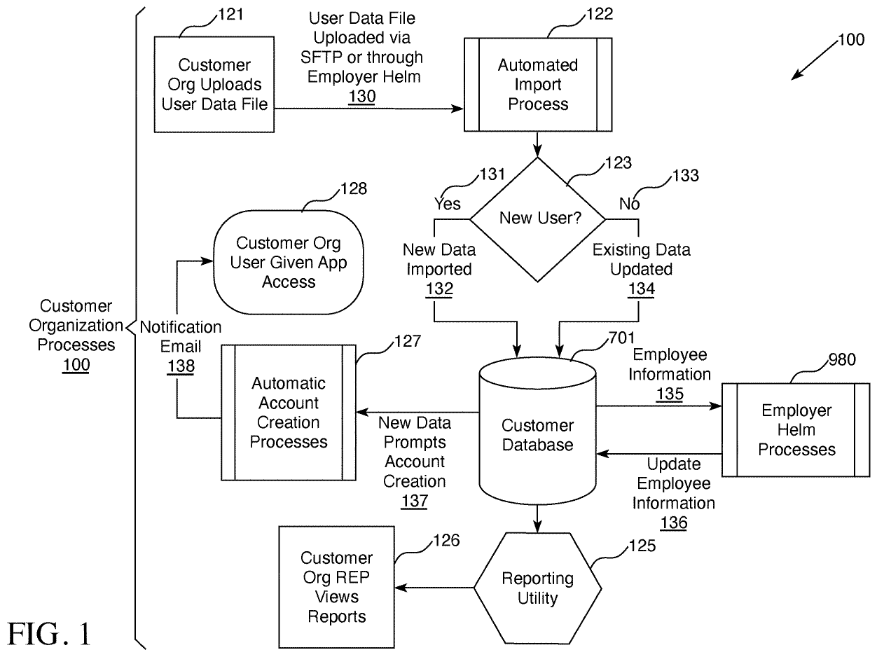

### Customer Database Data Flow 100 (FIG. 1)

FIG. 1 illustrates one embodiment of a customer organization process 100 according to some of the systems and methods of the present invention. For this embodiment, a customer organization 30 either connects to an SFTP folder and uploads a new user data file directly, or logs into the employer helm 980 and manually uploads a new user data file 121, 130 (see FIG. 1). An automated import process 122 imports new records into, or updates existing records within, that customer's database 701. The employer helm 980 also allows customer organizations 30 to directly edit some pieces of user data. A check is conducted on each record contained in the uploaded user data file 123, where if that record was just created, an automatic account creation process is triggered 127. This will send the new user a notification email 138 containing information on how to access and claim their new personal account, which grants that user access to the front-end application 128. The customer database 701 also feeds into a reporting utility 125. This allows the customer organization 30 to view various reports on how their associated users have been using services of the present invention 126.

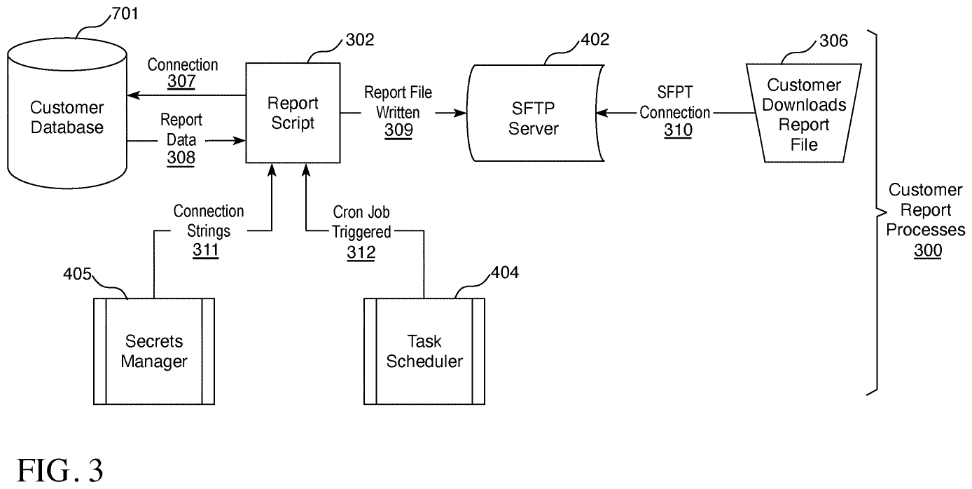

### Customer Report Download Process 300 (FIG. 3)

FIG. 3 illustrates one embodiment of a customer report process according to the various systems and methods of the present invention. For this embodiment, a task scheduler 404 on a server 910 maintains a cronjob 312 that triggers a report-writing script 302 on a regularly scheduled basis. When triggered, the report script 302 fetches the required connection information from a cloud-based secrets management service 311, 405 and connects to the appropriate customer database 307, 701. Report script 302 gathers pertinent user data, including attended events, ratings, budgets, etc. 308 from the customer database 701, and formats it into a more easily parsed .csv file. In one preferred embodiment of the present invention, personally identifiable information (“PII”) is not included in the report. The report script 302 saves this report file 309 on the appropriate customer's SFTP folder 402. The customer can securely connect 310 to the SFTP folder 402 and retrieve the report 306. Customer closes SFTP connection. See generally FIG. 3.

### Matching Helm Data Flow

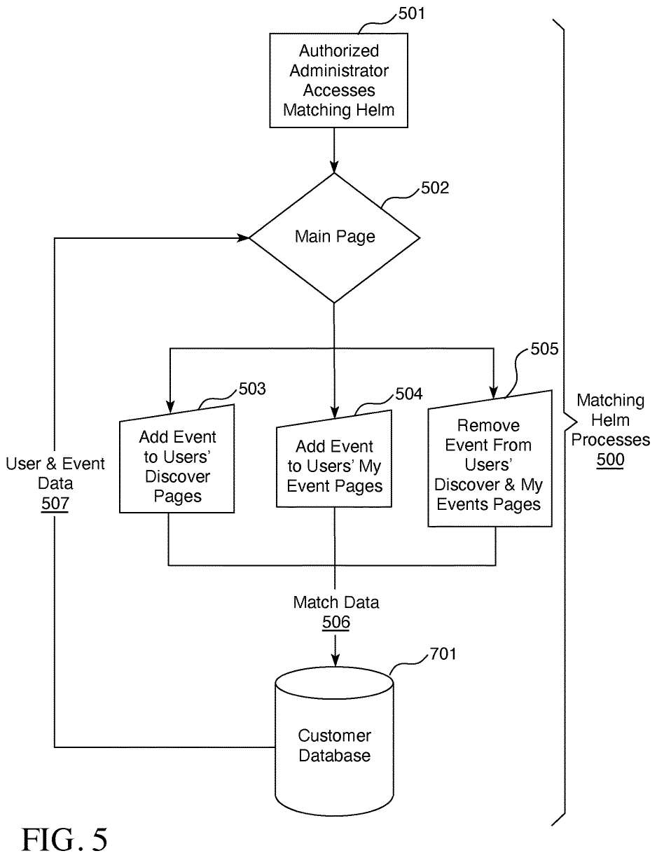

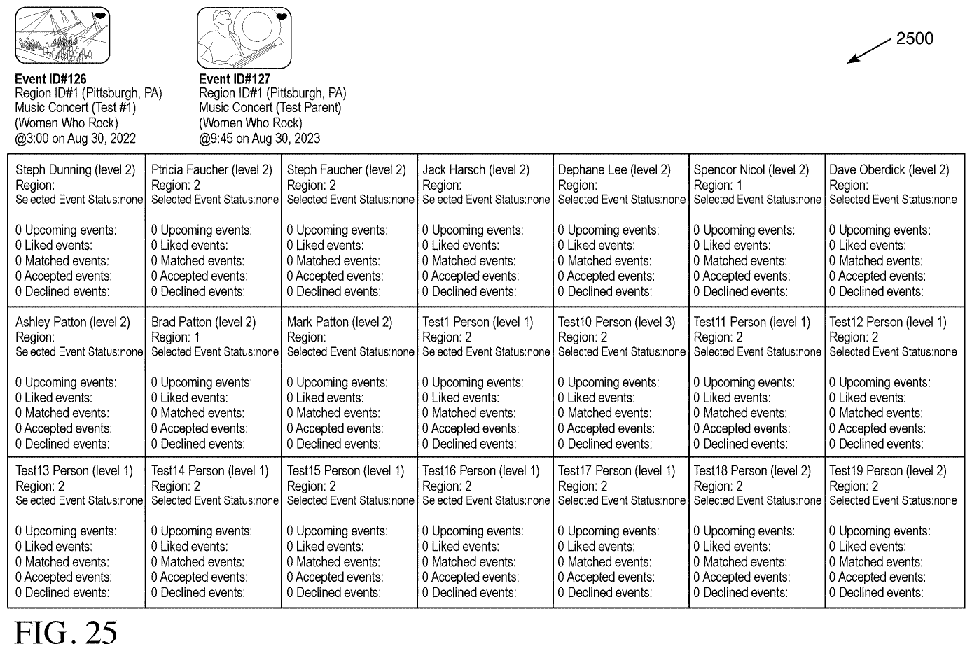

FIG. 5 illustrates one embodiment of a matching helm processes 500 according to the various methods and systems of the present invention. An authorized administrator logs into the matching helm (see FIG. 5 at 501, with the Matching Helm 950 shown generally in FIG. 9 and a specific embodiment of the Matching Helm 2500 shown in FIG. 25). An ‘authorized administrator’ 40 in this context can be an event manager or other similarly designated individual.

The main screen of the matching helm 502 (FIG. 5.2 and example screenshot is shown at FIG. 25) is populated from a customer database 507, 701 showing all upcoming events and active users associated with the database 701. Selecting an event will list the users and their status related to that event. One embodiment of the matching helm 950 also includes set of filters that can be applied to select certain subset of users 10, such as filtering on only users 10 who have indicated they are interested in the ‘Creativity & The Arts’ category, for example. These filters allow the administrators 40 to more easily and accurately create manual user-event matches.

For this embodiment of the present invention, on the main screen 502, once an event is selected, all users who are connected to that event will be color-coded to indicate their relation. With the event selected, different users then can be selected, cycling through the color-coding system to indicate the selected action. The color-coding system is used to indicate the current state of a user in relation to an event selected, such as if the user has been matched to the event already, has had the event shown on their discover page, or if the user declined to attend the event. All user-event relations are shown in this view, whether those relations were created manually through the Matching Helm 950 or if those relations were created through one of the two recommender module algorithms.

As a non-limiting example illustrated in FIG. 5, any type of highlighting or other tool can be employed to indicate that the event 252 will be added the user's discover page 503. A light green highlight to a selected user indicates that that user 10 will have that event 251 proposed to them on their my events page 504, matched together in an attendance group with any other selected users for that event 251. A dark green highlight indicates that the user 10 has accepted the event 250. No highlight indicates that the user 10 either had no connection to the event 251, or any connection they did have will be removed 505.

The administrator 40 can save the event/user groupings 20, at which point the changes are pushed back to the customer database 506, 701 (see FIG. 5).

Some embodiments of the present invention comprise a system 900 as described above wherein the step of generating personalized recommended events 251 to the user 10 based upon the user interest ratings 708 comprise at least the following three steps. First, generating recommended events 251 to the user 10 based upon the user's user profile 101 for the user 10 to rate by interest 708. Second, updating the user profile 101 based upon the user's interest ratings 708 of the recommended events 251. Third, generating matched events 251 to the user 10 based upon the updated user profile 101 and for the user 10 to accept or decline.

### Example User Experience

As a non-limiting example, a new user 10, who is an employee 10 of a customer organization 30 based in the Pittsburgh region, would take the onboarding questionnaire 704, which identifies their preferred networking outcomes, as well as how they prefer to network, and what their interests in events are. The present invention systems 900, methods 6000, and storage media 7000 then show to this user 10 events 251 on their discover page 705 that fit their expressed event interests, to get a better understanding of the types of events the user 10 is interested in. For example, a new user 10 may, on the questionnaire 704, indicates they are interested in City Exploration. The Discover Page 705 would then show them events 251 that fit that category 117, such as an exhibit at a local museum, a behind the scenes tour of a local sports stadium, and a historic local amusement park. The user 10 would then rate these events 708. As an example, they would highly rate the stadium tour and the amusement park.

Other examples of questions that can be included in various embodiments of the user questionnaire 704 are as follows:

How well do you know your colleagues? (single)
5 - Extremely well
4 - Very well
3 - Moderately well
2 - Slightly well
1 - Not well at all
How comfortable are you meeting new people? (single)
5 - Extremely comfortable
4 - Very comfortable
3 - Moderately comfortable
2 - Slightly comfortable
1 - Not comfortable at all
How do you prefer to meet new people? (single)
One-on-One
Small groups
No Preference
How often would you like to attend events? (single)
Weekly
Biweekly
Monthly
Quarterly
How far in advance would you like to receive event invites? (single)
As early as possible
Two weeks in advance
One week in advance
A few days in advance
The day of
During your average week, what days are you available to attend events?
(multi)
Monday
Tuesday
Wednesday
Thursday
Friday
Saturday
Sunday
During your average week, what days are you working in person at the
office? (multi)
Monday
Tuesday
Wednesday
Thursday
Friday
Remote Work Only
Do you intend to drive or use public transportation or both to events?
(single)
Drive
Public Transportation
Both
Which event categories interest you the most? (multi)
City Exploration
Creativity & the Arts
Educational Experiences
Entertainment & Hobbies
Food & Drink
Outdoor Recreation
Physical & Mental Wellness
Sports Activities & Games
How often do you participate in outdoor activities? (single)
5 - Always
4 - Often
3 - Sometimes
2 - Rarely
1 - Never
How adventurous are you? (single)
5 - Extremely adventurous
4 - Very adventurous
3 - Moderately adventurous
2 - Slightly adventurous
1 - Not adventurous at all
Which food categories interest you the most? (multi)
African
American
Asian
Caribbean
Coffee
Dessert
Italian
Latin American
Mediterranean
Do you have dietary restrictions? (multi)
Alcohol Free
Gluten Free
Hindu
Keto
Kosher
Muslim or Halal
Pescatarian
Vegan
Vegetarian
No Restrictions
Do you need any disability accommodations? (single, if yes −> manual
follow-up from BFM)
No
Yes

Taking the user's discover page rating information 708, the recommender modules 930, 940 would then suggest either one of those events directly, or an event that is similar in features, such as attending a local sporting event or concert. The frequency of these event recommendations 251 is set by the customer organization 30, and they are paid for (if required) out of a budget set by the organization 30. If the events 252 require payment, the cost and set budget can factor into recommendation 251. The group 20 that the user 10 would be included in to attend the event would be a set of their coworkers who have expressed similar interests in event types. The user 10 would then accept or decline to attend the suggested event in the application 920. As an example, this user 10 is suggested to attend a local football game 251 with a group 20 of coworkers who enjoy football or other sports. They accept the event and will be reminded of the event at regular intervals before the scheduled event time. In the example, the user 10 check into the event and/or attends the event at the scheduled time with their group 20 of coworkers who were also recommended the event 251. The systems 900, methods 6000, and storage media 7000 of the present invention list the meeting location for the group 20 attending the event 251, and encourages them to use the check-in feature, which allows the others in the group 20 to see they have arrived, as well as send chat messages to the attending group. After the football game 251 takes place, the user 10 is given a post-event survey 3400 where they are asked to rate the event and their group experience 711. This rating information is then used to create future event suggestions 251 and groupings 20.

Exceptions to this standard method can exist. For example, the grouping step of the recommender modules, where a user 10 is grouped with other employees 20 with similar event interests, may be overrode by the customer organization 30 if they wanted to instead group 20 their employees 10 according to different custom groupings, such as a specific university's alumni, or an ERG such as Women in Tech. An employer 30 could also use that grouping parameter as an event filtering parameter, such as sending an alumni group from a specific university to a sporting event at that university. As an example, using an ERG, an employer 30 could have employees 10 who are member of Women in Tech attend a Girls Who Code event. Add an exception for a user choosing to network with the same people again (repeating individual contact and group contact)

Customer organizations 30 could also request to upload their own events, such as a global volunteer day, or request that events be booked on a certain day. These customer-uploaded events would then be recommended only to that organization's users 10, who would still be grouped together based on their shared interests. For example, a group of employees 20 who all indicate enjoying animal-based events would be recommended to attend an event at a local animal shelter. Users 10 who may not enjoy the same type of community service would not be recommended that particular event and would instead be recommended either volunteer events related to their specific interests, or more general service events such as volunteering at a local food pantry.

Instead of the customer organization 30 setting the budget, the organization may instead have their user 10 set the budget, such as in the case of a college or university having their students set their own budgets. Similarly, a customer organization 30 may offload the payment onto the user as well, such as in the same college or university and student example. Frequency of event recommendations and bookings may also be offloaded onto the user from the customer organization 30.

The region that a user's events are selected from could also change, depending on the physical location of the user 10. If, for instance, the user 10 was travelling from their home in Pittsburgh to a conference in San Francisco, and their employer 30 wanted to allow them to attend events using the systems and methods of the present invention while at the conference, their region would temporarily change from Pittsburgh to San Francisco, and the events they would be recommended, or attend would change accordingly.

Some embodiments of the present invention can be configured to enable users 10 to select their own groups 20 during the event-group matching stage, to prioritize the growth of their network.

### Methods of Matching Users 10 and Events 252

As mentioned above, all of the variations of, steps of, parts of, and elements the various embodiments of systems 900 of the present invention can be distilled to analogous steps comprising a method 6000 of the present invention. In one broad preferred embodiment, the present invention is directed to a method 6000 for matching a user 10 with other users 10 in an organization 30 in connection with events 252. The method 6000 of this embodiment comprises an electronic system 8020 having at least one processor 8000, and a memory 8010 coupled to the at least one processor 8000 comprising instructions executable by the processor(s) 8000. The at least one processor 8000 operable when executing the instructions to perform at least the following six steps or functions. The processor(s) 8000 can receive event features 104 that are transmitted to the at least one processor 8000, the event features 104 predetermined by screening and selection based on a review of the event 252. The processor(s) 8000 can receive user data 110 from at least one user 10 that is transmitted to the at least one processor 8000 for creation of at least one user profile 101 based upon input 102 from the at least one user 10 as to user personal information, as well as user interest ratings 708, 711 of outcomes 740 and/or events 252. The processor(s) 8000 are configured to generate personalized recommended events 252 to the at least one user 10 based upon the user interest ratings 708 of the at least one user 10 and for the at least one user 10 to rate 708 and accept or decline 710. The processor(s) 8000 are configured to generate an event invitation 112 including event details 108 to the at least one user 10 for an event accepted 250 by the at least one user 10. The processor(s) 8000 are configured to update the user profile 101 of the at least one user 10 based upon the at least one user's rating and/or selection of events generated to, accepted by, declined by, and/or attended by the at least one user 10. The processor(s) 8000 are configured to generate new personalized recommended events 252 to the at least one user 10 on a periodic schedule and based upon the updated user profile 101 of the at least one user 10.

### Non-Transitory Computer-Readable Storage Medium 7000

As mentioned above, all of the variations of, steps of, parts of, and elements the various embodiments of systems 900 of the present invention can be distilled to analogous steps comprising a non-transitory computer-readable storage medium 7000 of the present invention. In one broad preferred embodiment, the present invention is directed to a non-transitory computer-readable storage medium 7000 storing one or more programs for matching a user 10 with other users 10 in an organization 30 in connection with events 252. For these embodiments, the one or more programs comprise instructions, which, when executed by at least one processor 8000 of an electronic system 8020, cause the electronic system 8020 to perform at least the following six steps/functions. The processor(s) 8000 can receive event features 104 that are transmitted to the at least one processor 8000, the event features 104 predetermined by screening and selection based on a review of the event 252. The processor(s) 8000 can receive user data 110 from at least one user 10 that is transmitted to the at least one processor 8000 for creation of at least one user profile 101 based upon input 102 from the at least one user 10 as to user personal information, as well as user interest ratings of outcomes 740 and/or events 252. The processor(s) 8000 are configured to generate personalized recommended events 251 to the at least one user 10 based upon the user interest ratings of the at least one user 10 and for the at least one user 10 to rate 708 and accept or decline 710. The processor(s) 8000 are configured to generate an event invitation 112 including event details 108 to the at least one user 10 for an event accepted 250 by the at least one user 10. The processor(s) 8000 are configured to update the user profile 101 of the at least one user 10 based upon the at least one user's rating and/or selection of events generated to, accepted by, declined by, and/or attended by the at least one user 10. The processor(s) 8000 are configured to generate new personalized recommended events 251 to the at least one user 10 on a periodic schedule and based upon the updated user profile 101 of the at least one user 10.

### Applications Beyond Employment Settings

While the various embodiments of the present invention presented herein are primarily in the context of an employment environment wherein the user 10 is an employee and the organization or customer 30 is an employer, the systems 900, methods 6000, and storage media 7000 of the present invention can be applied to a wide range of environments and relationships beyond employee-employer. Some non-limiting examples follow. The various embodiments of the present invention can be configured for use in educational settings, such as college and university settings, wherein the user is a student 10 and the customer 30 is the college or university and the goal is to better match students with networking opportunities with other students, teachers, or school administrators.

Another example is the use of the various embodiments of the present invention in the travel and travel booking industries. For this example, the user 10 is the individual 10 looking for travel opportunities and the customer 30 can be an employer 30 looking to book travel events 252 for employee(s) 10 For example, the systems 900, methods 6000, and storage medial 7000 of the present invention can be configures to facilitate the events 252 for a conference that the employer 30 is hosting in another city 116. In this context, the definition of an “event 252” is broader and includes events 252 that the user 10 needs or wants to attend regardless of whether the event is for networking purposes. Additionally, the systems 900, methods 6000, and storage media 7000 of the present invention can be configured to match users 10 to travel reservations (a type of “event”) including, but not limited to, different travel reservation types like hotel, airfare, ride share/pickup, daycare or pet sitting needs for traveling, meals, etc.

### TERMINOLOGY DICTIONARY

Accepted event 250: An accepted event 250 is a matched event 251 that has been accepted by the user 10.

Accepting an Event 710: When a user 10 accepts a matched event 251 on the main screen 2700 of the mobile application 920, they 10 indicate that they intend to attend the proposed event 251.

Administrators 40: An administrator is any individual or role that facilitates, administers, and/or manages the systems, methods, and storage mediums of the present invention. Administrators 40 include but are not limited to the following roles: authorized user, Regional Event Director, Event Coordinator, and Solutions Specialist. An administrator 40 may hold one or multiple roles.

Category 117: A category 117 is one of a set of attributes that some embodiments of the present invention use to broadly describe an event 252. An event 252 can have multiple categories 117. Users 10 also can be asked in an onboarding questionnaire 704 which categories 117 interest them most.

Cronjob 409: A cronjob 409 is a command or script that is set to run periodically at fixed times or intervals.

Customer 30: A customer 30 is any organization or entity that uses the systems 900, methods 6000, and/or storage devices 7000 of the present invention to provide networking or matching opportunities to individuals (users 10). For example, a customer 30 can be an employer 30 of a group 20 of individuals 10. Customers 30 are referred to herein interchangeably as “employers”, “customers”, “customer organizations”, “companies”, and “organizations”. The present invention can be used with any organization 30 that has individual members 10 associated with it 30 and is not limited to an employer/employee relationship.

Declining an event 710: When a user 10 declines an event 710 on the main screen 2700 of the mobile application 920, they 10 are indicating that they 10 either do not want to, or cannot, attend the proposed event 251.

Discover page 705, 2900: The discover page 705, 2900 is a page within the application 920 that shows users 10 a varied, mildly curated set of matched events 251. Users 10 will either express interest in these matched events 251 or ignore them. This expression of interest 708 is then used to create better user profiles 101 within the present invention's systems 900, storage media 7000, and methods 6000, so that events 252 may be better tailored to each individual user's preferences.

Discover page recommender module 930: The discover page recommender module 930 (also referred to as the “DP Recsys 930”) is a recommender module used primarily to generate personalized event suggestions 251 for users 10, which are then shown on their discover pages 705, 2900, and are used to gauge interest in different events 252 and to build more accurate user profiles 101.

Event 252: An event 252 is a planned social occurrence that has been entered into the systems 900, storage media 7000, and methods 6000 of the present invention. Events 252 can be extremely varied in all aspects, but all revolve around the idea that users 10 will attend them. Events 252, in a general sense, are run by vendors 50, and occur at venues 116. An event 252 also is referred to herein as a vetted event 252. Events 252 are available to be matched to users 10 and/or to groups 20. Events 252 which are vetted, unmatched events, can be proposed to users 10 to gauge the user's interest in an event 252 prior to the event 252 becoming a matched event 251. A user 10 can express interest in generic vetted events 252 and later express interest that same event 252 when it becomes a matched events 251 that is proposed to them or that they attended.

Event booking 253: An event booking 253 is a specifically created event occurrence 252 with a dedicated date and time, which is then able to be proposed to users 10. Event bookings 253 are created from in the live region database(s) 212 using vetted and approved parent event templates 254 via the event catalog 211 or vendor helm 1200.

Event catalog 211: The event catalog 211 is a utility interface that is used to create event bookings 253 in the present invention's systems 900, storage media 7000, and methods 6000. It 211 is accessible by administrators 40 (such as regional event directors and solutions specialists). It 211 allows for the creation of individual event bookings 253 and facilitates the management of those bookings 253 by administrators 40. The event catalog's main page 802 is shown in FIG. 8.

Event coordinator 40: An event coordinator 40 is an administrator 40 that is a contracted event enthusiast who is responsible for one of the event categories 117. They receive events 256 from the solutions specialist 40 to vet and gather data on the event 252 for use in the system 900.

Event data 108: Event data 108 are the inputs and information that are provided about an event 252. Event data 108 can be the same as event features 104 or it can be a larger amount of data than is included in the event features 104. Event data 108 also is referred to herein as “event details”.

Event features 104: Event features 104 can be the same as event data 108, but in most embodiments it 104 is a subset of event data 108 that is used by the matching algorithms.

Event feature profile 255: An event feature profile 255, within the context of the recommender modules, is a collection of all pertinent data 108 regarding an event 252. This includes venue 116, vendor 50, and any event management utilities 960 survey data, among other data points.

Liking or disliking an event 614, 708, 711, 713, 2030: A user 10 who likes or dislikes an event 614, 708, 711, 713, 2030 has applied a like or dislike to an event 251 or otherwise rated or indicated an interest in an event 251, 252 through any of the means discussed herein including but not limited to surveys and questionnaires. These concepts of liking, disliking, rating, and expressing an interest in are collectively referred to herein as an “user interest rating”. “User interest rating” also can include a user's responses to the employee questionnaire 704. This like, dislike, rating, and expression of interest serve as an interest (or lack thereof) flag, which is then used by the recommender modules 930, 940 to serve the user 10 more accurate future recommendations for events 251, within the discover page 705, the my events page 1203, the events for me page 706, and view past events 712 (see FIGS. 6, 7, and 12).

Live Database 212, 701, 1212: The present invention utilizes live regional databases 212 and live customer databases 701. A live database 212, 701, 1212 is a repository for a region's event data 108 that has been thoroughly vetted according to the systems and methods of the present invention or customer data 401. It is from live databases 212, 701, 1212, particularly the live regional databases 212, that the systems 900, methods 6000, and storage media 7000 of the present invention pull event data 108 to show to users 10.

Matched event 251: A matched event 251 is an event 252 that has been matched to at least one user 10 or group 20. A matched event 251 also is referred to herein as a recommended event 251. Matched events 251 can be accepted or declined/unaccepted.

Matching helm 500, 950, 2500: The matching helm 500, 950, 2500 is a utility interface that is used to manually match users 10 to events 252. Those matches can be either a user-to-event discover page match generated by the discover page recommendation module 930, or a user-to-event my events page 1203 match. The former indicates that the event 252 will appear on the user's discover page 705 (as a matched event 251), while the latter indicates that the user 10 will have that event 252 proposed to them on their my events page 1203, 3100 (as a matched event 251). The matching helm 500, 950, 2500 is also used to manually review and correct any of the matches that have been automatically generated by either of the recommender modules 930, 940.

Matching recommender module 940: The matching recommender module 940 is a recommender module used to generate groupings 20 of users 10 and propose an event 251 that fits the tastes and interests of the group 20 as whole. It prioritizes grouping users 10 who have had fewer past interactions, to help users 10 create larger social networks within the customer organization 30.

Mobile application (or app) 920: A mobile application 920 is the interface through which users 10 interact with the systems 900, methods 6000, and transitory storage mediums 7000 of the present invention. It 920 contains all the functionality required for users 10 to view, accept, decline, and rate their curated events 251, as well as options for their preferences within the app, including a questionnaire 704 for better event curation and notification settings 707, 3200.

My events page 1203, 1440, 3100: The my events page 1203, 1440, 3100 is a page within the application 920 where users 10 can view their curated event attendance proposals 251, as well as view their upcoming events and previously attended unrated events. From the my events page 1203, 1440, 3100, a user 10 can view or decline upcoming events, check-in to events when they arrive at the venue 116, chat with other attendees, and view and rate 711 previously attended events. The rating of previously attended events 711 feeds information into the recommender modules 930, 940 for more accurate future recommendations.

Organization 30: An organization 30 is any user of the employer helm 980. Organizations 30 can be, and are referred to interchangeably as, “employers”, “customers”, “customer organizations”, and “companies”.

Outcome 740: An outcome 740 is a goal of an event 252 or of the matching of an event 251 to a user 10 or to a group 20. An outcome 740 can be articulated by a user 10, by a group 20, or by an organization 30. A user interest rating also can include the user's rating 711 of desired social outcomes 740 at the event.

Parent event/event template 254: A parent event 254, also called an event template 254, is an event 252 that is planned to be repeated in some form or capacity in the future. As a non-limiting example, a generic football game 252 may be entered in the event catalog 211 as a parent event 254, at which point future specific football games would be created from that parent event 254, utilizing a prefilled event template 254.

Partnered vendor 55: A partnered vendor 55 is any vendor 50 that has been vetted and allowed to access directly the vendor portal 1200 themselves to enter and edit events 252 that they themselves will host. Partnered vendors 55 are an optional component of the systems 900, methods 6000, and storage mediums 7000 of the present invention.

Previous event history 712, 3200: The previous event history page 712, 3200 is a page within the application 920 where a user 10 can view, apply likes to, or remove likes from, their previously attended and rated events.

Rating an event 711: A user 10 who rates an event 711 has performed a post-event survey 3400 after attending the event 252, which asks the user 10 to answer a variety of questions regarding how they felt about attending the event 252. These ratings 711 serve as the basis for creating user profiles 101 within the recommender modules 930, 940 that feed the systems 900, methods 6000, and storage mediums 7000 of the present invention.

Region 232: A region 232 is a physical area from which local events are collected into the systems 900, methods 6000, and storage mediums 7000 of the present invention. In one embodiment of the present invention, a region 232 is a city or other such metropolitan area, in which a customer organization 30 is either primarily situated, or has a substantial subset of employees 10 who work out of that area.

Regional event director 40: A regional event director is an administrator 40 who hires, onboards, and manages the regional event team administrators 40. They are responsible for creating and maintaining vendor 50 relationships and evaluating success metrics. They have permission to add, edit or delete event information on the event management utilities 960.

Secrets management service 405: A secrets management service 405 is a cloud-based secure storage system that is used for the storing and accessing of database connection strings, passwords, and other sensitive data. These can be prebuilt tools and services provided by a variety of cloud service providers, such as Amazon Web Services®. They 405 function similarly to password managers, with the key distinction that secrets managers 405 are able to be accessed via machines, such as automated scripts or applications.

Solutions specialist 40: A solutions specialist 40 is an administrator 40 and is an administrative and research support person to the regional events team and directly reports to the regional event director 40. They 40 are responsible for assigning events to event coordinators 40, coordinating event team calendars, meeting calendars of the event director 40, conducting event intake research, and updating events.

Staging database 210, 1202: A staging database 210, 1202 (also referred to as a staging region database 210, 1202 is a repository for a single region's event data 108 that has been entered into the vetting portal 200, 1400 by one or more administrators 40. Data on the staging database 210, 1202 is not shown anywhere to users 10, it must first be approved by an administrator 40, like a regional event director, at which point it can be used on the event catalog 211 to create live event bookings.

Task scheduler 404: A task scheduler 404 is an application that runs on the servers 910 that handles the scheduling and triggering of the various cronjobs 409 that the present invention systems 900, methods 6000, and storage mediums 7000.

Unaccepted event 257: An unacceptable event 257 is a matched event 251 that has not yet been accepted by the user 10 or has been declined by the user 10.

Unvetted event 256: An unvetted event 256 is a draft event that is not yet in the live event catalog 212 and is not ready to be matched to users 10 and/or groups 20. Once an unvetted event 256 has been vetted it becomes an event 252 and can be moved to the live database 212.

User 10: A user 10 is any individual with access to an application 920 associated with the present invention, who is connected in some way to a customer 30. For example, a user 10 is an employee 10 of the customer organization 30. Users 10 are referred to herein interchangeably as “employees 10”, “individuals 10”, “members 10”, or “users 10”.

User data 110: User data 110 is information about a user 10 that is entered into the systems 900, methods 6000, and storage media 7000 of the present invention by the organization 30. Nonlimiting examples of user data 110 are employee ranks, titles, and human resource information kept by the organization 30 on the user 10.

User features 103: User features 103 is all, or a subset of, user data 110 and user input 102. In most embodiments of the present invention, user features 103 is the information about a user 10 that is fed into the recommendation modules of the present invention and used for event matching.

User input 102: User input 102 is information that a user 10 provides or enters about themselves. In most embodiments of the present invention, user input 102 is entered via the questionnaire 704.

User interest rating, user rating, or user interest (“user interest rating”): Liking or disliking an event 614, 708, 711, 713, 2030, rating, or indicating an interest in an event 251, 252 through any of the means discussed herein including but not limited to surveys and questionnaires are collectively referred to herein as a user interest rating. User interest rating also can include a user's responses to the employee questionnaire 704. This like, dislike, rating, and expression of interest serve as an interest (or lack thereof) flag, which is then used by the recommender modules 930, 940 to serve the user 10 more accurate future recommendations for events 251, within the discover page 705, the my events page 1203, the events for me page 706, and view past events 712 (see FIGS. 6, 7, and 12).

User profile 101 or user feature profile 101: A user profile 101 (also referred to herein as a “user feature profile 101”), within the context of the recommender modules 930, 940, is a collection of all pertinent data the system 900, method 6000, or storage medium 7000 has collected regarding a user's preferences towards events. This includes their event likes, event ratings, and questionnaire answers, among other data points.

Vendor 50: A vendor 50 is any entity that is hosting, coordinating, advertising, or running an event 252 that is or may be included in the systems 900, methods 6000, or storage mediums 7000 of the present invention. In some embodiments of the present invention, an employer or organization 30 also can be a vendor 50 by creating and/or proposing their own events that, for example, they are hosting at their office.

Vendor portal 1200: The vendor portal 1200 (also referred to herein as a vendor helm 1200) is a specialized version of the event catalog 211 usable by partnered vendors 55 and regional event directors 40. It 1200 is used to create event bookings that are hosted or being run directly by the partnered vendor 55, request event booking cancellations, and as a contact method with the regional event director 40. Partnered vendors 55 have limited editing capabilities in the vendor portal 1200 compared to what is available in the event catalog 211.

Venue 116: A venue 116 is any location or place where an event 252 has occurred or is scheduled to occur.

Vetting events 200: Vetting an event 200 is the process of thoroughly reviewing an event 256, vendor 50, and venue 116 by and administrator 40 affiliated with populating the systems 900, methods 6000, or storage mediums 7000 of the present invention with event information and/or event features 104 prior to any inclusion of the event 252 in a user's experience or discover page 705. There are varying vetting processes 200 and review forms 203 to 209, 1440, 1500, 1600, 2200, 2300, 1490 that are used depending on the phase of market rollout and type of vendor 50 being vetted. All events must be vetted and approved by an administrator(s) 40 before the event can be proposed to users 10.

Vetting portal 200, 1400: The vetting portal 200, 1400 is a utility interface that is used to enter events into the present invention's systems 900, methods 6000, or storage mediums 7000. It is accessible by an administrator 40 (for example, regional event directors, solutions specialists, and category specialists). It consists of all forms required to collect the information that the present invention's systems 900, methods 6000, or storage mediums 7000 deem necessary to thoroughly vet and review events, vendors, and venues. One example of an administrator's vetting portal 200 is shown in FIG. 2. This vetting portal 200 is how an administrator 40 accesses the various vetting portal processes (numbered 203 through 209 in FIG. 2) through the vetting portal main page 202. The vetting portal processes 200 interact with the staging region database 210, which feeds information into the event catalog 211 and then the event/venue/vendor data goes into the live region database 212.

### Hardware

Embodiments of the present invention (particularly systems 900 and methods 6000) include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. These steps and operations (including but not limited to all of the processes, steps and operations illustrated in the flowcharts of FIGS. 1 through 13) can be performed by a variety of different combinations of hardware and software including but not limited to a variety of applications, modules, databases, servers, processors, memory, and electronic systems that can be hardwired together or can communicate with one another through a wide variety of other means (including without limitation, Wi-Fi, Bluetooth®, cellular connectivity, etc.) The various databases of the present invention, including, the customer database 701 (FIGS. 1, 3-7, 10, 11, and 13) the region database 212 (FIGS. 2, 6, 8, and 12), and the staging database 210 (FIGS. 2, 8, and 12) can incorporate one or more processor(s) 8000, memory 8010, and/or electronic systems 8020 to enable them to function, process the input and provide the output of the various systems 900 and methods 6000 of the present invention. Additionally, other databases beyond the three specified herein can be incorporated into the various embodiments of the present invention to accomplish the stated goals.

As such, FIGS. 6, 7 and 9 show one embodiment of a computer system with which embodiments of the present invention may be utilized. According to the present example, the computer system includes at least one processor 8000, and a memory 8010 coupled to the at least one processor 8000 comprising instructions executable by the at least one processor 8000, the at least one processor 8000 operable when executing the instructions to: (1) receive event features 104 that are transmitted to the at least one processor 8000, the event features 104 predetermined by screening and selection based on a review of the event 252; (2) receive user features 103 from at least one user 10 that is transmitted to the at least one processor 8000 for creation of at least one user profile 101 based upon user input 102 and user data 110, as well as user interest ratings 711 of events 251, 252; (3) generate personalized recommended events 251 to the at least one user 10 based upon the user interest ratings of the at least one user 10 and for the at least one user 10 to rate and accept or decline 710; (4) generate an event invitation 112 including event data 108 to the at least one user 10 for an event accepted 250 by the at least one user 10; (5) update the user profile 101 of the at least one user 10 based upon the at least one user's interest ratings and/or selection of events generated to 251, accepted by 250, declined by 257, and/or attended by the at least one user 10; and (6) generate new personalized recommended events 251 to the at least one user 10 on a periodic schedule and based upon the updated user profile 101 of the at least one user 10. More specifically, the instructions can be executed to: (1) receive event features 104 that are transmitted to a live region database 212, the event features 104 predetermined by screening and selection based on a review of the event 252; (2) receive user data 110 from at least one user 10 that is transmitted to a customer database 701 for creation of at least one user profile 101 based upon input from the at least one user 10 as to user personal information, as well as user interest ratings of outcomes 740 and/or events 251, 252; (3) generate personalized recommended events 251 to the at least one user 10 based upon the user interest ratings of the at least one user 10 and for the at least one user 10 to rate 711 and accept or decline 710; (4) generate an event invitation 112 from a notifications and alert system (EM Recsys 940), the event invitation 112 including event data 108 to the at least one user 10 for an event accepted 250 by the at least one user 10; (5) update the user profile 101 of the at least one user 10 in the customer database 701 based upon the at least one user's rating 711 and/or selection of events generated to 251, accepted by 250, and/or attended by the at least one user; and (6) generate new personalized recommended events 251 to the at least one user 10 on a periodic schedule and based upon the updated user profile 101 of the at least one user 10. Further, the step of generating personalized recommended events 251 to the at least one user 10 based upon the user interest ratings of the at least one user 10 can further comprise the steps of: (1) generating recommended events through a discovery page recommendation module 930 (see FIGS. 6, 7, and 9) to the at least one user 10 based upon the at least one user's user profile 101 and for the at least one user 10 to rate by interest 711; (2) updating the at least one user profile 101 based upon the at least one user's interest ratings of the recommended events 251 (see FIG. 6); and (3) generating matched events 251 through an event matching recommendation module 940 (see FIGS. 6 and 9) to the at least one user 10 based upon the updated user profile 101 and for the at the least one user to accept or decline 710 (see FIG. 7). These steps can be repeated in the operation of the system and methods of the present invention. Referring to FIGS. 6 and 9, customer database 701, live region database 212, discovery page recommendation module 930, and EM Recsys 940, along with other modules and systems of the invention, all are associated with at least one processor 8000, and a memory 8010 coupled to the at least one processor 8000.

The present invention also includes a non-transitory computer-readable storage medium 7000 storing one or more programs for matching a user 10 with other users 10 in an organization 30 in connection with events 252, the one or more programs comprising instructions, which, when executed by at least one processor 8000 of an electronic system 8020, cause the electronic system 8020 to: (1) receive event features 104 that are transmitted to the at least one processor 8000, the event features 104 predetermined by screening and selection based on a review of the event 252; (2) receive user data 110 from at least one user 10 that is transmitted to the at least one processor 8000 for creation of at least one user profile 101 based upon input 102 from the at least one user 10 as to user personal information, as well as user interest ratings of outcomes 740 and/or events 251, 252; (3) generate personalized recommended events 251 to the at least one user 10 based upon the user interest ratings of the at least one user 10 and for the at least one user 10 to rate and accept or decline 710; (4) generate an event invitation 112 including event data 108 to the at least one user 10 for an event accepted 250 by the at least one user 10; (5) update the user profile 101 of the at least one user 10 based upon the at least one user's rating 711 and/or selection of events generated to 251, accepted by 250, declined by 257, and/or attended by the at least one user 10; and (6) generate new personalized recommended events 251 to the at least one user 10 on a periodic schedule and based upon the updated user profile 101 of the at least one user 10.

Processor(s) 8000 can be any known processor, such as, but not limited to, an Intel® Itanium® or Itanium 2® processor(s), or AMD® Opteron® or Athlon MP® processor(s), or Motorola® lines of processors. Communication port(s) can be any of an RS-232 port for use with a modem-based dialup connection, a 10/100 Ethernet port, or a Gigabit port using copper or fiber. Communication port(s) may be chosen depending on a network such a Local Area Network (“LAN”), Wide Area Network (“WAN”), or any network to which the computer system connects.

Memory 8010 can be Random Access Memory (“RAM”), or any other dynamic storage device(s) commonly known in the art. Read only memory can be any static storage device(s) such as Programmable Read Only Memory (“PROM”) chips for storing static information such as instructions for processor. Memory 8010 also can be any mass storage devices can be used to store information and instructions. For example, hard disks such as the Adaptec® family of SCSI drives, an optical disc, an array of disks such as RAID, such as the Adaptec family of RAID drives, or any other mass storage devices may be used. Finally, memory 8010 can be any removable storage media can be any kind of external hard-drives, floppy drives, IOMEGA® Zip Drives, Compact Disc-Read Only Memory (“CD-ROM”), Compact Disc-Re-Writable (“CD-RW”), Digital Video Disk-Read Only Memory (“DVD-ROM”).

While the disclosure has been described in detail and with reference to specific embodiments thereof, it will be apparent to one skilled in the art that various changes and modifications can be made therein without departing from the spirit and scope of the embodiments. Thus, it is intended that the present disclosure covers the modifications and variations of this disclosure provided they come within the scope of the appended claims and their equivalents.

1. A system for matching a user with other users in an organization in connection with events, the system comprising: at least one processor, and a memory coupled to the at least one processor comprising instructions executable by the at least one processor, the at least one processor operable when executing the instructions to:
receive event features that are transmitted to the at least one processor, the event features predetermined by screening and selection based on a review of the event;
receive user features from at least one user that are transmitted to the at least one processor for creation of at least one user profile based upon user input and user data, as well as user interest ratings of events;
generate personalized recommended events to the at least one user based upon the user interest ratings of the at least one user and for the at least one user to rate and accept or decline;
generate an event invitation including event data to the at least one user for an event accepted by the at least one user;
update the user profile of the at least one user based upon the at least one user's interest ratings and/or selection of events generated to, accepted by, declined by, and/or attended by the at least one user; and
generate new personalized recommended events to the at least one user on a periodic schedule and based upon the updated user profile of the at least one user.

2. The system of claim 1, wherein the screening and selection of the predetermined event features is based on review of features of an event vendor, event location, event venue and/or event activity.

3. The system of claim 1, wherein the user profile of the at least one user is generated, in part, from answers provided by the at least one user to a user questionnaire, wherein the answers are associated with weighted parameters within the process of generating personalized recommended events.

4. The system of claim 1, wherein the process for generating personalized recommended events is selected based upon whether a predetermined user ratings threshold is met, and with the user ratings threshold analogous to the number of events that the at least one user has rated before attending an event.

5. The system of claim 1, wherein the event data generated to the at least one user for an event accepted by the at least one user includes other users who have accepted the event.

6. The system of claim 1, wherein an administrator of the system can segment and prioritize certain groupings of users for personalized event recommendations, along with associated budgets.

7. The system of claim 1, wherein the at least one processor is further operable when executing instructions to:
find and match users together by prioritizing the creation of groups of users that have had few interactions with each other in the past.

8. The system of claim 1, wherein an administrator of the system can manually select specific events to be included in recommended events.

9. The system of claim 1, wherein the at least the user interest ratings are provided in response to a questionnaire.

10. The system of claim 1, wherein the user interest ratings also include the at least one user's rating of desired social outcomes at the event.

11. The system of claim 1, wherein the step of generating personalized recommended events to the at least one user based upon the user interest ratings of the at least one user further comprises:
generating recommended events to the at least one user based upon the at least one user's user profile and for the at least one user to rate by interest;
updating the at least one user profile based upon the at least one user's interest ratings of the recommended events; and
generating matched events to the at least one user based upon the updated user profile and for the at the least one user to accept or decline.

12. A method for matching a user with other users in an organization in connection with events, the method comprising:
an electronic system having at least one processor, and a memory coupled to the at least one processor comprising instructions executable by the processors, the at least one processor operable when executing the instructions to:
receive event features that are transmitted to the at least one processor, the event features predetermined by screening and selection based on a review of the event;
receive user data from at least one user that is transmitted to the at least one processor for creation of at least one user profile based upon input from the at least one user as to user personal information, as well as user interest ratings of outcomes and/or events;
generate personalized recommended events to the at least one user based upon the user interest ratings of the at least one user and for the at least one user to rate and accept or decline;
generate an event invitation including event data to the at least one user for an event accepted by the at least one user;
update the user profile of the at least one user based upon the at least one user's rating and/or selection of events generated to, accepted by, declined by, and/or attended by the at least one user; and
generate new personalized recommended events to the at least one user on a periodic schedule and based upon the updated user profile of the at least one user.

13. The method of claim 12, wherein the screening and selection of the predetermined event features is based on review of features of event vendor, event location, event venue and/or event activity.

14. The method of claim 12, wherein the user profile of the at least one user is generated, in part, from answers provided by the at least one user to a user questionnaire, wherein the answers are associated with weighted parameters within the process of generating personalized recommended events.

15. The system of claim 12, wherein an administrator of the system can segment and prioritize certain groupings of users for personalized event recommendations, along with associated budgets.

16. The method of claim 12, wherein the event data generated to the at least one user for an event accepted by the at least one user includes other users who have accepted the event.

17. A non-transitory computer-readable storage medium storing one or more programs for matching a user with other users in an organization in connection with events, the one or more programs comprising instructions, which, when executed by at least one processor of an electronic system, cause the electronic system to:
receive event features that are transmitted to the at least one processor, the event features predetermined by screening and selection based on a review of the event;
receive user data from at least one user that is transmitted to the at least one processor for creation of at least one user profile based upon input from the at least one user as to user personal information, as well as user interest ratings of outcomes and/or events;
generate personalized recommended events to the at least one user based upon the user interest ratings of the at least one user and for the at least one user to rate and accept or decline;
generate an event invitation including event data to the at least one user for a event accepted by the at least one user;
update the user profile of the at least one user based upon the at least one user's rating and/or selection of events generated to, accepted by, declined by, and/or attended by the at least one user; and
generate new personalized recommended events to the at least one user on a periodic schedule and based upon the updated user profile of the at least one user.

18. A system for matching a user with other users in an organization in connection with events, the system comprising: at least one processor, and a memory coupled to the at least one processor comprising instructions executable by the at least one processor, the at least one processor operable when executing the instructions to:
receive event features that are transmitted to the at least one processor, the event features predetermined by screening and selection based on a review of the event;
receive user data from at least one user that is transmitted to the at least one processor for creation of at least one user profile based upon input from the at least one user as to user personal information, as well as user interest ratings of outcomes and/or events;
generate personalized recommended events to the at least one user based upon the user interest ratings of the at least one user and for the at least one user to rate and accept or decline;
generate an event invitation including event data to the at least one user for an event accepted by the at least one user; and
update the user profile of the at least one user based upon the at least one user's rating and/or selection of events generated to, accepted by, and/or attended by the at least one user.

19. A system for matching a user with other users in an organization in connection with events, the system comprising: at least one processor, and a memory coupled to the at least one processor comprising instructions executable by the at least one processor, the at least one processor operable when executing the instructions to:
receive event features that are transmitted to a live region database, the event features predetermined by screening and selection based on a review of the event;
receive user data from at least one user that is transmitted to a customer database for creation of at least one user profile based upon input from the at least one user as to user personal information, as well as user interest ratings of outcomes and/or events;
generate personalized recommended events to the at least one user based upon the user interest ratings of the at least one user and for the at least one user to rate and accept or decline;
generate an event invitation from a notifications and alert system the event invitation including event data to the at least one user for an event accepted by the at least one user;
update the user profile of the at least one user in the customer database based upon the at least one user's rating and/or selection of events generated to, accepted by, and/or attended by the at least one user; and
generate new personalized recommended events to the at least one user on a periodic schedule and based upon the updated user profile of the at least one user.

20. The system of claim 19, wherein the wherein the step of generating personalized recommended events to the at least one user based upon the user interest ratings of the at least one user further comprises:
generating recommended events through a discovery page recommendation module to the at least one user based upon the at least one user's user profile and for the at least one user to rate by interest; and
updating the at least one user profile based upon the at least one user's interest ratings of the recommended events; and
generating matched events through an event matching recommendation module to the at least one user based upon the updated user profile and for the at the least one user to accept or decline.
